(19) United States
(12) Patent Application Publication
(10) Pub. No.: US 2023/0359041 A1
(43) Pub. Date: Nov. 9, 2023

(54) LIGHT GUIDE DISPLAY SYSTEM INCLUDING FREEFORM VOLUME GRATING

(71) Applicant: Meta Platforms Technologies, LLC, Menlo Park, CA (US)

(72) Inventors: Changwon JANG, Kirkland, WA (US); Miaomiao XU, JR., Redmond, WA (US)

(21) Appl. No.: 18/301,012

(22) Filed: Apr. 14, 2023

Related U.S. Application Data
(60) Provisional application No. 63/338,109, filed on May 4, 2022.

(51) Int. Cl. G02B 27/01; F21V 8/00

(52) U.S. Cl. CPC G02B 27/0172; G02B 6/0035; G02B 2027/0123

(57) ABSTRACT

A device is provided. The device includes a light guide coupled with an in-coupling element at an input portion of the light guide and an out-coupling element at an output portion of the light guide. The device also includes a volume grating disposed at a portion of the light guide and configured to diffract a light via Bragg diffraction. The volume grating is configured with at least one of a predetermined spectral Bragg selectivity variation or a predetermined angular Bragg selectivity variation along one or more dimensions in a film plane of the volume grating.

### CROSS REFERENCE TO RELATED APPLICATION

This application claims the benefit of priority to U.S. Provisional Application No. 63/338,109, filed on May 4, 2022. The content of the above-mentioned application is incorporated herein by reference in its entirety.

### TECHNICAL FIELD

The present disclosure generally relates to optical devices and, more specifically, to a light guide display system including a freeform volume grating.

### BACKGROUND

An artificial reality system, such as a head-mounted display (“HMD”) or heads-up display (“HUD”) system, generally includes a near-eye display (“NED”) system in the form of a headset or a pair of glasses. The NED system is configured to present content to a user via an electronic or optic display disposed about 10-20 mm in front of the eyes of a user. The NED system may display virtual objects or combine images of real objects with virtual objects, as in virtual reality (“VR”), augmented reality (“AR”), or mixed reality (“MR”) applications. For example, in an AR system, a user may view both images of virtual objects (e.g., computer-generated images (“CGIs”)) and the surrounding environment by, for example, seeing through transparent display glasses or lenses (also referred to as an optical see-through AR system). One example of an optical see-through AR system is a pupil-expansion light guide display system, in which an image light representing a CGI may be coupled into a light guide (e.g., a transparent substrate) to propagate inside the light guide, and be coupled out of the light guide at different locations to expand an effective pupil.

### SUMMARY OF THE DISCLOSURE

Consistent with an aspect of the present disclosure, a device is provided. The device includes a light guide coupled with an in-coupling element at an input portion of the light guide and an out-coupling element at an output portion of the light guide. The device also includes a volume grating disposed at a portion of the light guide and configured to diffract a light via Bragg diffraction. The volume grating is configured with at least one of a predetermined spectral Bragg selectivity variation or a predetermined angular Bragg selectivity variation along one or more dimensions in a film plane of the volume grating.

Consistent with another aspect of the present disclosure, a device is provided. The device includes a light guide coupled with an in-coupling element at an input portion of the light guide. The device also includes a volume grating embedded in the light guide, and configured with at least one of a predetermined spectral Bragg selectivity variation or a predetermined angular Bragg selectivity variation along one or more dimensions in a film plane of the volume grating. The in-coupling element is configured to couple an input light into the light guide as an in-coupled light propagating toward the volume grating. The volume grating is configured to diffract the in-coupled light out of the light guide.

Other aspects of the present disclosure can be understood by those skilled in the art in light of the description, the claims, and the drawings of the present disclosure. The foregoing general description and the following detailed description are exemplary and explanatory only and are not restrictive of the claims.

### BRIEF DESCRIPTION OF THE DRAWINGS

The following drawings are provided for illustrative purposes according to various disclosed embodiments and are not intended to limit the scope of the present disclosure. In the drawings:

FIG. 1A schematically illustrates a diagram of a light guide display system, according to an embodiment of the present disclosure;

FIGS. 1B-1E schematically illustrate spectral and/or angular Bragg selectivity variation of a freeform volume grating included in the light guide display system shown in FIG. 1A, according to various embodiments of the present discourse;

FIG. 1F schematically illustrates a diagram of a light guide included in the light guide display system shown in FIG. 1A, according to an embodiment of the present disclosure;

FIGS. 2A-2E schematically illustrate parameter variations of a freeform volume grating along one or two dimensions in a film plane of the freeform volume grating, according to various embodiments of the present discourse;

FIG. 3 schematically illustrates a diagram of a light guide display system, according to an embodiment of the present disclosure;

FIGS. 4A and 4B schematically illustrate a diagram of a light guide display system, according to an embodiment of the present disclosure;

FIGS. 5A and 5B schematically illustrate a diagram of a light guide display system, according to an embodiment of the present disclosure;

FIG. 6A schematically illustrates a diagram of a light guide display system, according to an embodiment of the present disclosure;

FIG. 6B schematically illustrates a portion of the light guide display system shown in FIG. 6A, according to an embodiment of the present disclosure;

FIG. 6C schematically illustrates a portion of the light guide display system shown in FIG. 6A, according to an embodiment of the present disclosure;

FIG. 7A schematically illustrates a diagram of a light guide display system, according to an embodiment of the present disclosure;

FIG. 7B schematically illustrates a portion of the light guide display system shown in FIG. 7A, according to an embodiment of the present disclosure;

FIG. 8A illustrates a schematic diagram of an artificial reality device, according to an embodiment of the present disclosure; and

FIG. 8B schematically illustrates a cross-sectional view of half of the artificial reality device shown in FIG. 8A, according to an embodiment of the present disclosure.

### DETAILED DESCRIPTION

Embodiments consistent with the present disclosure will be described with reference to the accompanying drawings, which are merely examples for illustrative purposes and are not intended to limit the scope of the present disclosure. Wherever possible, the same reference numbers are used throughout the drawings to refer to the same or similar parts, and a detailed description thereof may be omitted.

Further, in the present disclosure, the disclosed embodiments and the features of the disclosed embodiments may be combined. The described embodiments are some but not all of the embodiments of the present disclosure. Based on the disclosed embodiments, persons of ordinary skill in the art may derive other embodiments consistent with the present disclosure. For example, modifications, adaptations, substitutions, additions, or other variations may be made based on the disclosed embodiments. Such variations of the disclosed embodiments are still within the scope of the present disclosure. Accordingly, the present disclosure is not limited to the disclosed embodiments. Instead, the scope of the present disclosure is defined by the appended claims.

As used herein, the terms “couple,” “coupled,” “coupling,” or the like may encompass an optical coupling, a mechanical coupling, an electrical coupling, an electromagnetic coupling, or any combination thereof. An “optical coupling” between two optical elements refers to a configuration in which the two optical elements are arranged in an optical series, and a light output from one optical element may be directly or indirectly received by the other optical element. An optical series refers to optical positioning of a plurality of optical elements in a light path, such that a light output from one optical element may be transmitted, reflected, diffracted, converted, modified, or otherwise processed or manipulated by one or more of other optical elements. In some embodiments, the sequence in which the plurality of optical elements are arranged may or may not affect an overall output of the plurality of optical elements. A coupling may be a direct coupling or an indirect coupling (e.g., coupling through an intermediate element).

The phrase “at least one of A or B” may encompass all combinations of A and B, such as A only, B only, or A and B. Likewise, the phrase “at least one of A, B, or C” may encompass all combinations of A, B, and C, such as A only, B only, C only, A and B, A and C, B and C, or A and B and C. The phrase “A and/or B” may be interpreted in a manner similar to that of the phrase “at least one of A or B.” For example, the phrase “A and/or B” may encompass all combinations of A and B, such as A only, B only, or A and B. Likewise, the phrase “A, B, and/or C” has a meaning similar to that of the phrase “at least one of A, B, or C.” For example, the phrase “A, B, and/or C” may encompass all combinations of A, B, and C, such as A only, B only, C only, A and B, A and C, B and C, or A and B and C.

When a first element is described as “attached,” “provided,” “formed,” “affixed,” “mounted,” “secured,” “connected,” “bonded,” “recorded,” or “disposed,” to, on, at, or at least partially in a second element, the first element may be “attached,” “provided,” “formed,” “affixed,” “mounted,” “secured,” “connected,” “bonded,” “recorded,” or “disposed,” to, on, at, or at least partially in the second element using any suitable mechanical or non-mechanical manner, such as depositing, coating, etching, bonding, gluing, screwing, press-fitting, snap-fitting, clamping, etc. In addition, the first element may be in direct contact with the second element, or there may be an intermediate element between the first element and the second element. The first element may be disposed at any suitable side of the second element, such as left, right, front, back, top, or bottom.

When the first element is shown or described as being disposed or arranged “on” the second element, term “on” is merely used to indicate an example relative orientation between the first element and the second element. The description may be based on a reference coordinate system shown in a figure, or may be based on a current view or example configuration shown in a figure. For example, when a view shown in a figure is described, the first element may be described as being disposed “on” the second element. It is understood that the term “on” may not necessarily imply that the first element is over the second element in the vertical, gravitational direction. For example, when the assembly of the first element and the second element is turned 180 degrees, the first element may be “under” the second element (or the second element may be “on” the first element). Thus, it is understood that when a figure shows that the first element is “on” the second element, the configuration is merely an illustrative example. The first element may be disposed or arranged at any suitable orientation relative to the second element (e.g., over or above the second element, below or under the second element, left to the second element, right to the second element, behind the second element, in front of the second element, etc.).

When the first element is described as being disposed “on” the second element, the first element may be directly or indirectly disposed on the second element. The first element being directly disposed on the second element indicates that no additional element is disposed between the first element and the second element. The first element being indirectly disposed on the second element indicates that one or more additional elements are disposed between the first element and the second element.

The term “processor” used herein may encompass any suitable processor, such as a central processing unit (“CPU”), a graphics processing unit (“GPU”), an application-specific integrated circuit (“ASIC”), a programmable logic device (“PLD”), or any combination thereof. Other processors not listed above may also be used. A processor may be implemented as software, hardware, firmware, or any combination thereof.

The term “controller” may encompass any suitable electrical circuit, software, or processor configured to generate a control signal for controlling a device, a circuit, an optical element, etc. A “controller” may be implemented as software, hardware, firmware, or any combination thereof. For example, a controller may include a processor, or may be included as a part of a processor.

The term “non-transitory computer-readable medium” may encompass any suitable medium for storing, transferring, communicating, broadcasting, or transmitting data, signal, or information. For example, the non-transitory computer-readable medium may include a memory, a hard disk, a magnetic disk, an optical disk, a tape, etc. The memory may include a read-only memory (“ROM”), a random-access memory (“RAM”), a flash memory, etc.

The term “film,” “layer,” “coating,” or “plate” may include rigid or flexible, self-supporting or free-standing film, layer, coating, or plate, which may be disposed on a supporting substrate or between substrates. The terms “film,” “layer,” “coating,” and “plate” may be interchangeable.

The wavelength ranges, spectra, or bands mentioned in the present disclosure are for illustrative purposes. The disclosed optical device, system, element, assembly, and method may be applied to a visible wavelength band, as well as other wavelength bands, such as an ultraviolet (“UV”) wavelength band, an infrared (“IR”) wavelength band, or a combination thereof. The term “substantially” or “primarily” used to modify an optical response action, such as transmit, reflect, diffract, block or the like that describes processing of a light means that a major portion, including all, of a light is transmitted, reflected, diffracted, or blocked, etc. The major portion may be a predetermined percentage (greater than 50%) of the entire light, such as 100%, 98%, 90%, 85%, 80%, etc., which may be determined based on specific application needs.

The term “orthogonal” as used in “orthogonal polarizations” or the term “orthogonally” as used in “orthogonally polarized” means that an inner product of two vectors representing the two polarizations is substantially zero. For example, two lights or beams with orthogonal polarizations (or two orthogonally polarized lights or beams) may be two linearly polarized lights (or beams) with two orthogonal polarization directions (e.g., an x-axis direction and a y-axis direction in a Cartesian coordinate system) or two circularly polarized lights with opposite handednesses (e.g., a left-handed circularly polarized light and a right-handed circularly polarized light).

The term “diffraction efficiency” as used herein is a quantitative measurement of the extent to which energy of an incident light is diffracted by a diffractive element. The diffraction efficiency may be defined as a ratio between an intensity (or optical power) of a diffracted light output from the diffractive element and an intensity (or optical power) of the incident light. The diffraction efficiency of the diffractive element may be calculated for a specific incident light, or a specific polarized component in the incident light. The diffraction efficiency for a specific polarized component in an incident light may be the same as or may be different from the diffraction efficiency for the overall incident light.

A conventional light guide display system may include a light source assembly configured to output an image light representing a virtual image, and an image combiner configured to guide the image light with an input FOV to an eye-box region of the system. The image combiner may also transmit a light from a real world environment to the eye-box region, such that an eye of a user located within the eye-box region may observe a virtual scene optically combined with a real world scene. The image combiner may include a light guide coupled with multiple couplers, which at least include an in-coupling element (or input coupler) and an out-coupling element (or output coupler). The in-coupling element may couple the image light into the light guide as an in-coupled image light that propagates inside the light guide toward the out-coupling element via total internal reflection (“TIR”). For convenience, the in-coupled image light that propagates inside and along the light guide (e.g., generally in a longitudinal direction of the light guide from the in-coupler to the out-coupler) may be referred to as a TIR propagating image light. The out-coupling element may couple the TIR propagating image light, which may be incident onto different portions of the out-coupling element while propagating along and inside the light guide through TIR, out of the light guide as a plurality of output image lights. In this manner, the image combiner may replicate the image light received from the light source assembly as multiple output image lights with substantially the same output FOV, thereby expanding an effective pupil of the light guide display system.

In the conventional light guide display system, the spatial and/or angular illuminance distribution (or profile) at the output side of the light guide is often uncontrolled. For example, the illuminance in different FOV directions of the output FOV may be different, and/or the illuminance at different portions of (or spatially separated locations within) the eye-box region may be different, providing a poor visual effect to a user. In some applications, it may be desirable to have a uniform spatial illuminance distribution and/or a uniform angular illuminance distribution at the output side of the light guide. For example, to increase the uniformity of the spatial illuminance distribution at the output side of the light guide, a partial reflector may be disposed inside the light guide to partially reflect and partially transmit the TIR propagating image light. The partial reflector may reflect about 50% of the TIR propagating image light and transmit about 50% of the TIR propagating image light, independent of the incidence angle and the incidence position of the TIR propagating image light. In some applications, it may be desirable to have a controlled, pre-configured non-uniform spatial and/or angular illuminance distribution at the output side of the light guide. The conventional light guide display system may not provide a controlled, pre-configured non-uniform spatial and/or angular illuminance distribution at the output side of the light guide.

The present disclosure provides a light guide (or waveguide) image combiner configured to provide a predetermined spatial illuminance distribution (or profile) and/or a predetermined angular illuminance distribution (or profile) at the output side of the light guide, such as a uniform spatial illuminance distribution and/or a uniform angular illuminance distribution, or a controlled, pre-configured non-uniform spatial illuminance distribution and/or a controlled, pre-configured non-uniform angular illuminance distribution. The light guide image combiner may be a light guide coupled with diffractive couplers (referred to as a diffractive light guide image combiner), or a light guide including embedded reflective couplers (referred to as a geometric light guide image combiner), or a light guide including an embedded reflective coupler and coupled with a diffractive coupler (referred to as a mixed light guide image combiner).

In some embodiments, the light guide image combiner may include one or more freeform volume gratings disposed at an input portion of the light guide, at an output portion of the light guide, and/or at a portion of the light guide between the input portion and the output portion. In some embodiments, the freeform volume grating may be fabricated based on a refractive index modulated photopolymer, or polarization volume hologram. The freeform volume grating may be configured with a predetermined spectral Bragg selectivity variation (e.g., a Bragg wavelength variation) and/or a predetermined angular Bragg selectivity variation (e.g., a Bragg angle variation) in one or two dimensions in a film plane of the freeform volume grating, for realizing the predetermined spatial and/or angular illuminance distribution at the output side of the light guide. The film plane of the freeform volume grating may be a plane perpendicular to a thickness direction of the freeform volume grating, and parallel with at least one of the surfaces of the freeform volume grating in the thickness direction. The freeform volume grating having a controllable spectral and/or angular Bragg selectivity variation may provide an additional degree of freedom in the light guide design for optimizing the performance of the system.

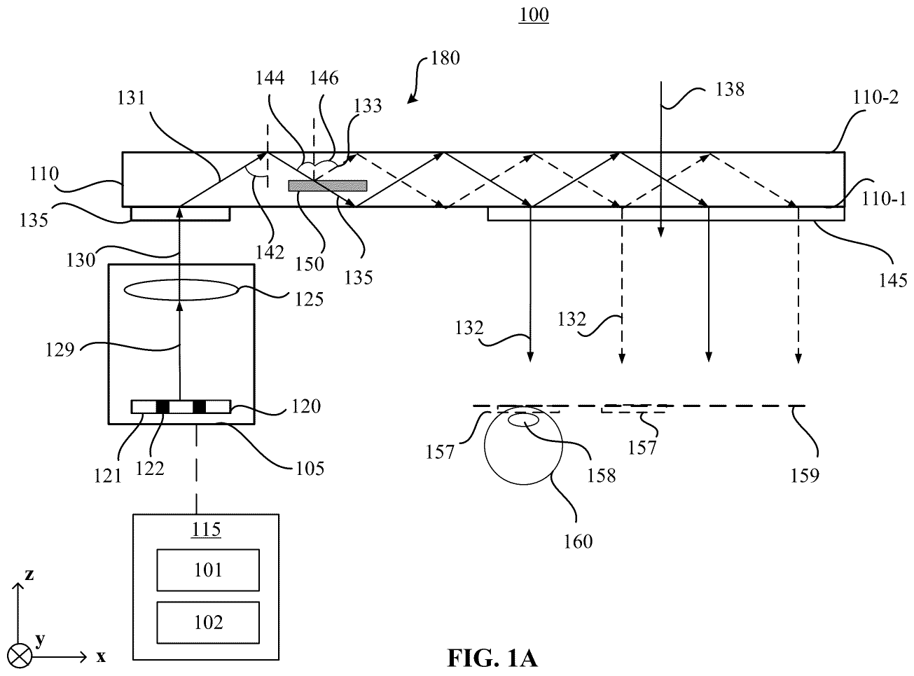

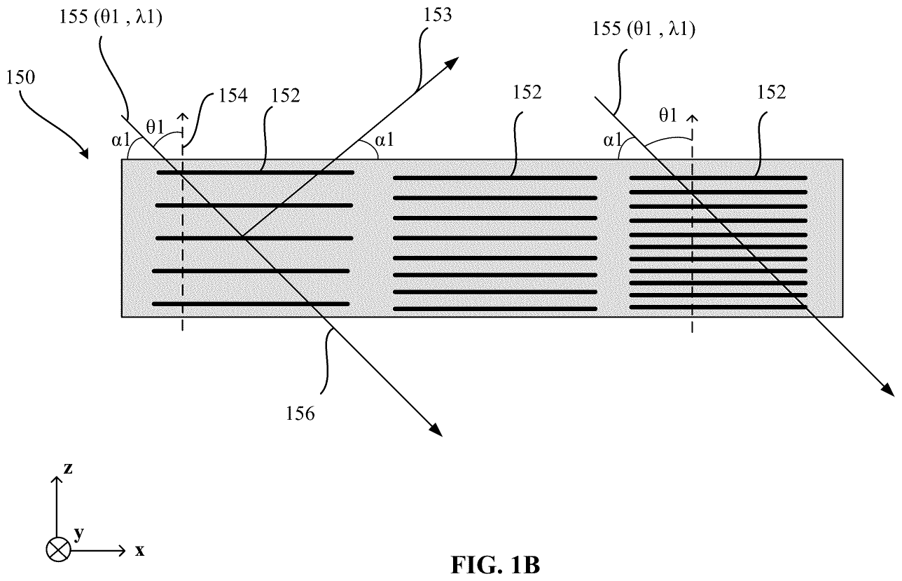

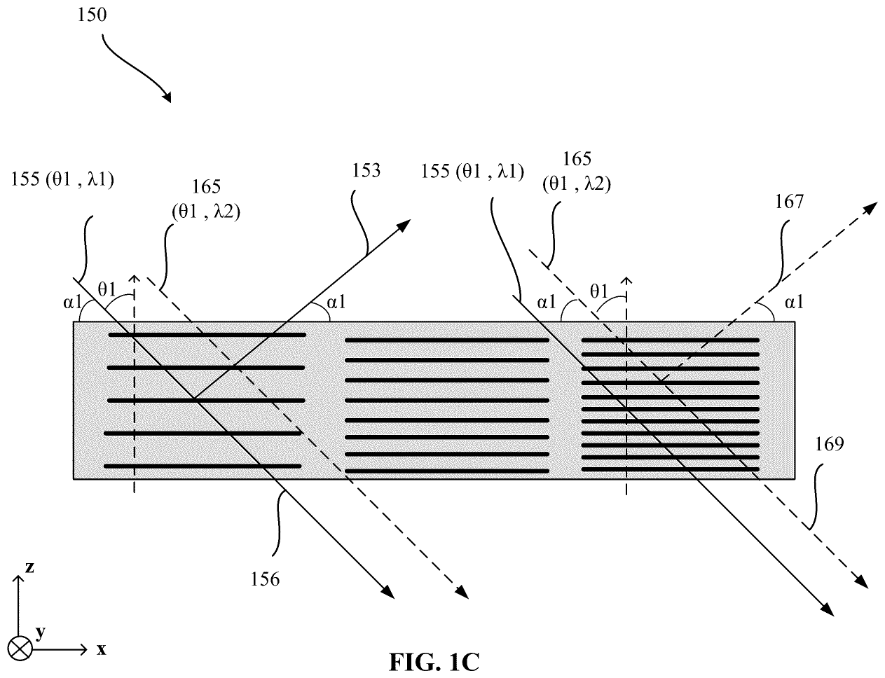

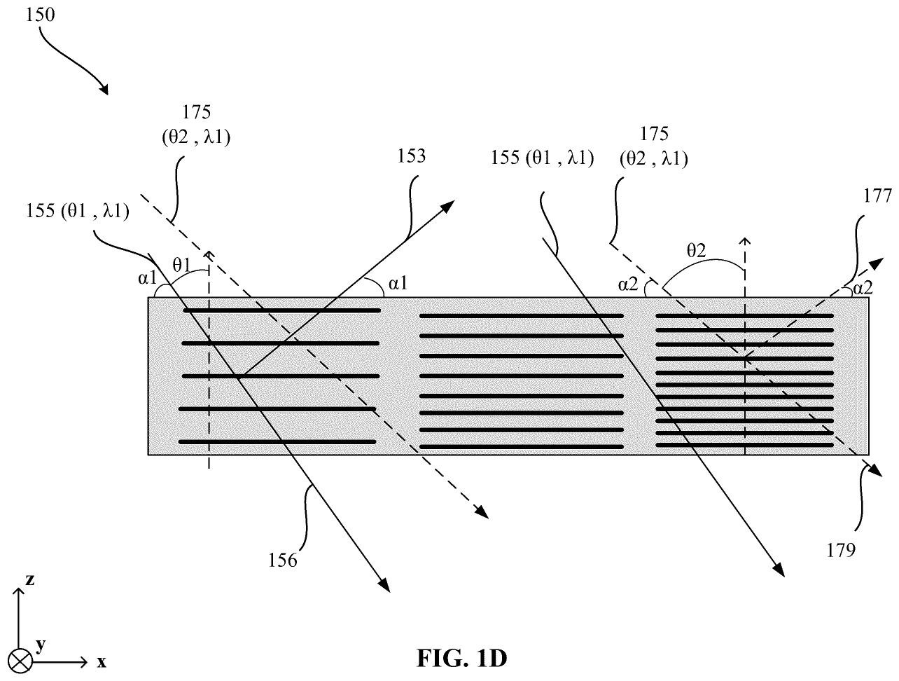

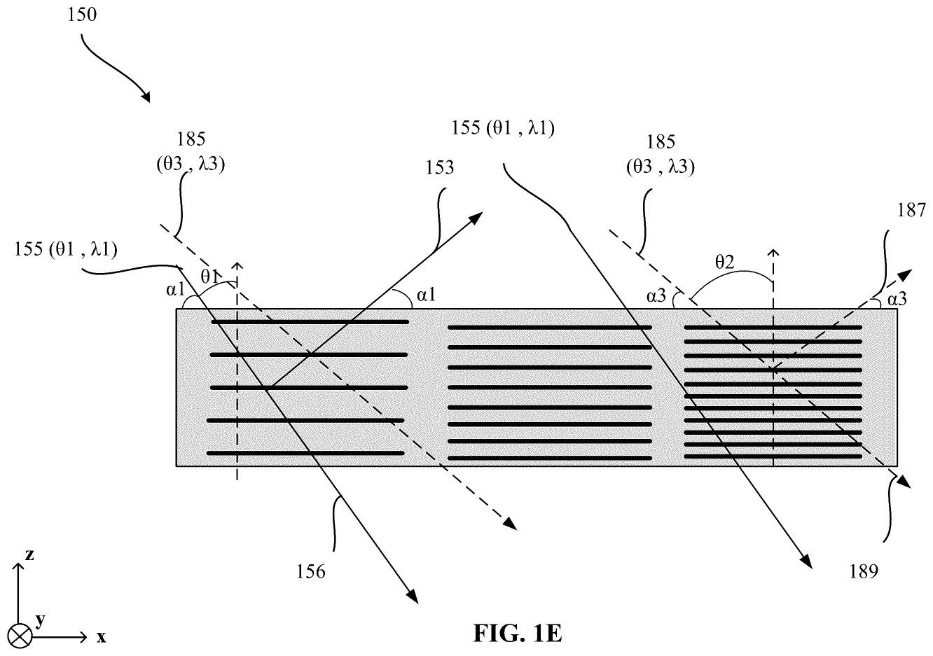

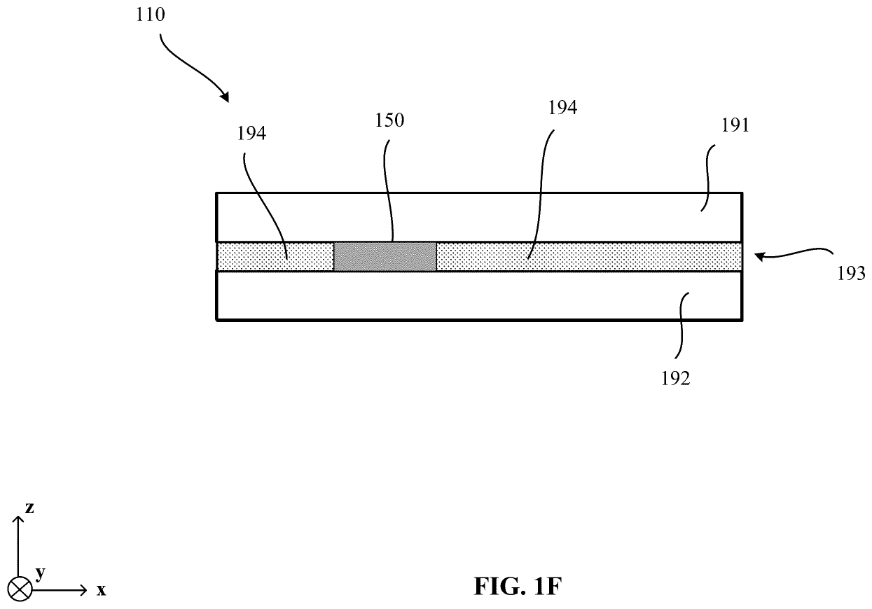

FIG. 1A illustrates an x-z sectional view of a light guide display system or assembly 100, according to an embodiment of the present disclosure. The light guide display system 100 may be a part of a system for AR, MR, and/or VR applications (e.g., an NED, an HUD, an HMD, smart glasses, a smart phone, a laptop, or a television, etc.). As shown in FIG. 1A, the light guide display system 100 may include a controller 115, a light source assembly 105, a light guide 110, an in-coupling element (or input coupler) 135 coupled with the light guide 110 at the input portion of the light guide 110, and an out-coupling element (or output coupler) 145 coupled with the light guide 110 at the output portion of the light guide 110. The light guide display system 100 may also include at least one holographic optical element (“HOE”) 150 disposed at a portion of the light guide 110 adjacent or at the input portion of the light guide 110, a portion of the light guide 110 adjacent or at the output portion of the light guide 110, and/or a middle portion between the input portion and the output portion. In some embodiments, the HOE 150 may be disposed entirely inside the body of the light guide 110. For discussion purposes, FIG. 1A shows that the light guide display system 100 includes a single HOE 150 disposed inside (or embedded in) the light guide 110. The combination of the light guide 110, the input coupler 135, the output coupler 145, and the HOE 150 may also be referred to as a light guide image combiner 180.

The light source assembly 105 may be configured to output an image light 130 representing a virtual image. The light guide image combiner 180 may be configured to guide the image light 130 to propagate through a plurality of exit pupils 157 positioned in an eye-box region 159 of the system 100. The exit pupil 157 may be a spatial location in the eye-box region 169 where an eye pupil 158 of an eye 160 of a user of the system 100 may be positioned to receive the content of the virtual image generated by the light source assembly 105.

The controller 115 may be communicatively coupled with the light source assembly 105, and may control the operations of the light source assembly 105 to generate the image light 130. The controller 115 may include a processor or processing unit 101 and a storage device 102. The storage device 102 may be a non-transitory computer-readable medium, such as a memory, a hard disk, etc., for storing data, information, and/or computer-executable program instructions or codes. The light source assembly 105 may include a display element 120 and a collimating lens 125. The display element 120 may include a display panel, such as a liquid crystal display (“LCD”) panel, a liquid-crystal-on-silicon (“LCoS”) display panel, an organic light-emitting diode (“OLED”) display panel, a micro-OLED display panel, a light-emitting diode (“LED”) display panel, a micro light-emitting diode (“micro-LED”) display panel, a laser scanning display panel, a digital light processing (“DLP”) display panel, or a combination thereof. In some embodiments, the display element 120 may include a self-emissive panel (including a plurality of self-emissive light sources or light emitting units), such as an OLED display panel, a micro-OLED display panel, an LED display panel, a micro-LED display panel, or a laser scanning display panel. In some embodiments, the display element 120 may include a display panel that is illuminated by an external source, such as an LCD panel, an LCoS display panel, or a DLP display panel. Examples of an external source may include a laser diode, a vertical cavity surface emitting laser, a light emitting diode, or a combination thereof.

For discussion purposes, FIG. 1A shows that the display panel includes a plurality of pixels 121 arranged in an pixel array, in which neighboring pixels 121 may be separated by, e.g., a black matrix 122. For illustrative purposes, FIG. 1A shows that the display element 120 includes three pixels 121. The display element 120 may output an image light 129 representing a virtual image (having a predetermined image size associated with a linear size of the display panel) toward the collimating lens 125. For example, each pixel 121 may output a bundle of divergent rays toward the collimating lens 125, and the respective bundle of divergent rays output from respective pixels 121 together may form the image light 129. The collimating lens 125 may be configured to condition the image light 129 to output the image light 130 having a predetermined input FOV (e.g., a) toward the light guide 110.

The collimating lens 125 may transform a linear distribution of pixels in the virtual image formed by the image light 129 into an angular distribution of pixels in the image light 130 having the predetermined input FOV. For example, the collimating lens 125 may convert the respective bundles of divergent rays output from the respective pixels 121 into respective bundles of parallel rays representing respective FOV directions of the input FOV. The respective bundles of parallel rays together may form the image light 130. For discussion purposes, FIG. 1A only shows a single ray of the image light 129 that is a central ray of a bundle of divergent rays output from the central pixel 121 of the display element 120, and the collimating lens 125 converts the ray of the image light 129 into a ray of the image light 130 that represents the zero-degree FOV direction of the input FOV.

The light guide 110 may have a first surface 110-1 facing a real world environment, and a second surface 110-2 opposite to the first surface 110-1 and facing the eye 160 of a user of the system 100. The light guide 110 may include one or more materials configured to facilitate the TIR propagation of an image light inside the light guide 110. The material of the light guide 110 may be optically transparent in an operation wavelength range of the system 100, e.g., a visible wavelength range and/or an infrared wavelength range. The light guide 110 may include, for example, a plastic, a glass, and/or a polymer.

In some embodiments, the input coupler 135 may be disposed at a first portion (e.g., the input portion) of the light guide 110. The output coupler 145 may be disposed at a second portion (e.g., the output portion) of the light guide 110. The first portion and the second portion may be located at different locations of the light guide 110. In some embodiments, each of the input coupler 135 and the output coupler 145 may be formed or disposed at (e.g., affixed to) the first surface 110-1 or the second surface 110-2 of the light guide 110. In some embodiments, each of the input coupler 135 and the output coupler 145 may be integrally formed as a part of the light guide 110, or may be a separate element coupled to the light guide 110. For discussion purposes, FIG. 1A shows that the input coupler 135 and the output coupler 145 may be formed or disposed at (e.g., affixed to) the same surface, e.g., the first surface 110-1 of the light guide 110. In some embodiments, although not shown, the input coupler 135 and the output coupler 145 may be formed or disposed at (e.g., affixed to) the second surface 110-2 of the light guide 110. In some embodiments, the input coupler 135 and the output coupler 145 may be formed or disposed at (e.g., affixed to) different surfaces of the light guide 110.

In some embodiments, the input coupler 135 may deflect the image light 130 to couple the image light 130 into a TIR path inside the light guide 110. The in-coupled image light 130 may propagate through TIR inside the light guide 110 as a TIR propagating image light 131. The TIR propagating image light 131 may propagate inside the light guide 110 toward the output coupler 145 via TIR, with a TIR propagation angle 142. When a light propagates within the light guide 110 through TIR, the angle formed by the TIR path of a light/ray and the normal of the surface of the light guide 110 (or the incidence angle of the light/ray incident onto the inner surface of the light guide 110) may be referred to as a TIR guided angle or a TIR propagation angle. In some embodiments, the TIR propagation angle 142 of the TIR propagating image light 131 may be maintained to be substantially the same as the TIR propagating image light 131 propagates inside the light guide 110 toward the output coupler 145 via TIR. The output coupler 145 may deflect the TIR propagating image light 131 to couple the TIR propagating image light 131 out of the light guide 110.

In some embodiments, the input coupler 135 and/or the output coupler 145 may include one or more gratings, one or more cascaded reflectors, one or more prismatic surface elements, and/or an array of holographic reflectors, or any combination thereof. The input coupler 135 and/or the output coupler 145 may be active or passive, and may be polarization sensitive (or polarization selective) or polarization insensitive (or polarization non-selective). Examples of gratings may include a surface relief grating, a volume grating, a metasurface grating, etc. Examples of volume gratings may include a volume holographic grating or volume Bragg grating, a polarization hologram grating based on liquid crystals (“LCs”), a polarization hologram grating based on a birefringent photo-refractive holographic material other than LCs, a polarization hologram grating based on sub-wavelength structures, etc. The grating may be a reflective or transmissive grating. The grating may be a passive or active grating. The grating may be polarization sensitive (or polarization selective) or polarization insensitive (or polarization non-selective).

For illustrative and discussion purposes, in the embodiment shown in FIG. 1A, each of the input coupler 135 and the output coupler 145 may be configured to include a grating. For discussion purposes, the input coupler 135 and the output coupler 145 may also be referred to as the in-coupling grating 135 and the out-coupling grating 145, respectively. In the embodiment shown in FIG. 1A, for discussion purposes, the in-coupling grating 135 may be a reflective grating, and the out-coupling grating 145 may be a transmissive grating. For example, the in-coupling grating 135 may couple, via forward diffraction, the image light 130 into a TIR path inside the light guide 110.

The TIR propagating image light 131 may propagate inside the light guide 110 toward the HOE 150 via TIR, may be incident onto the HOE 150 with an incidence angle 144 that is equal to the TIR propagation angle 142 of the TIR propagating image light 131. The HOE 150 may be disposed inside the light guide 110, between the first surface 110-1 and the second surface 110-2 of the light guide 110. In some embodiments, the HOE 150 may not be attached to or bonded to the first surface 110-1 or the second surface 110-2 of the light guide 110. That is, in some embodiments, the HOE 150 may be entirely embedded inside the light guide 110. The HOE 150 may be disposed between the in-coupling grating 135 and the out-coupling grating 145, e.g., in a longitudinal direction (e.g., x-axis direction) of the light guide 110 shown in FIG. 1A.

For example, in some embodiments, as shown in FIG. 1F, the light guide 110 may include a first transparent substate 191 and a second transparent 192 that are arranged in parallel and opposite to one other. The first transparent substate 191 and the second transparent 192 may be optically transparent in the operation wavelength range of the system 100. A space 193 with a predetermined gap may be formed between the first transparent substate 191 and the second transparent 192. In some embodiments, the HOE 150 may be disposed in a portion of the space 193 (not the entire space 193), and the remaining portions of the space 193 may be filled with a material 194 that is optically transparent in the operation wavelength range of the system 100. The material 194 may surround all side surfaces of the HOE 150 except for the upper and lower surfaces of the HOE 150. The material 194 may be configured with a refractive index that is substantially close to (including matching with or the same as) the refractive index of the first transparent substate 191 or the second transparent 192.

In the longitudinal direction (e.g., x-axis direction), the length of the HOE 150 may be smaller than the length of the light guide 110. For example, the length of the HOE 150 may be 1/10, ⅕, etc., of the length of the light guide 110. The length of the HOE 150 relative to the length of the light guide 110 may be determined based on specific applications. The thickness of the HOE 150 may be smaller than the thickness of the light guide 110. For example, the thickness of the HOE 150 may be ⅕, ⅙, 1/7, or 1/10 of the thickness of the light guide 110. The thickness of the HOE 150 relative to the thickness of the light guide 110 may be determined based on specific applications.

Referring back to FIG. 1A, the HOE 150 may be configured to convert the TIR propagating image light 131 into a diffracted order, e.g., a diffracted image light 133 (e.g., via backward diffracting) and a transmitted order, e.g., a transmitted image light 135. In some embodiments, the HOE 150 may be configured to substantially maintain the TIR propagation angle 142 of the TIR propagating image light 131 inside the light guide 110, while diffracting or transmitting the in-coupled image light 131. For example, a diffraction angle 146 of the diffracted image light 133 may be equal to the incidence angle 144 of the in-coupled image light 131 onto the HOE 150, which is the same as the TIR propagation angle 142 of the TIR propagating image light 131. In some embodiments, the HOE 150 may be configured to change the TIR propagation angle 142 of the TIR propagating image light 131 inside the light guide 110 to another predetermined, different TIR propagation angle, while diffracting the TIR propagating image light 131.

The light intensities of the diffracted image light 133 and the transmitted image light 135 may be configured through configuring the parameters of the HOE 150. For example, in some embodiments, the light intensities of the diffracted image light 133 and the transmitted image light 135 may be substantially the same. In some embodiments, the light intensity of the diffracted image light 133 may be greater (e.g., significantly greater when the HOE 150 substantially diffracts the TIR propagating image light 131) or less (e.g., significantly less when the HOE 150 substantially transmits the TIR propagating image light 131) than the light intensity of the transmitted image light 135.

The out-coupling grating 145 may couple, via diffraction, the image lights 133 and 135 out of the light guide 110. The out-coupling grating 145 may consecutively couple the image lights 133 and 135, which are incident onto the different positions of the out-coupling grating 145, out of the light guide 110 as a plurality of output image lights 132 at different positions of the out-coupling grating 145. For discussion purpose, FIG. 1A shows that the out-coupling grating 145 consecutively couples the image lights 133 and 135 out of the light guide 110 as the output image lights 132 at different locations along the longitudinal direction (e.g., x-axis direction) of the light guide 110. Each output image light 132 may have an output FOV (e.g., a) that may be substantially the same as the input FOV (e.g., a) of the input image light 130. Thus, the input image light 130 may be replicated as multiple output image lights 132 at the output side of the light guide 110, expanding an effective pupil of the light guide display system 100.

The respective output image lights 132 may propagate toward the respective exit pupils 157 positioned in the eye-box region 159 of the light guide display system 100. The output image lights 132 may one-to-one correspond to the exit pupils 157. The size of a single exit pupil 157 may be larger than and comparable with the size of the eye pupil 158. The exit pupils 157 may be sufficiently spaced apart, such that when one of the exit pupils 157 substantially coincides with the position of the eye pupil 158, the remaining one or more exit pupils 157 may be located beyond the position of the eye pupil 158 (e.g., falling outside of the eye pupil 158). Compared to a conventional light guide display system without the HOE 150, the number of exit pupils 157 may be increased (e.g., doubled) within the same eye-box region 159. In some embodiments, the illuminance uniformity over the entire eye-box region 159 may be improved. In some embodiments, the light guide 110 and the out-coupling grating 145 may also transmit a light 138 from a real-world environment (referred to as a real world light 138), combining the real world light 138 with the output image light 132 and delivering the combined light to the eye 160. Thus, the eye 160 may observe the virtual scene optically combined with the real world scene.

For discussion purposes, FIG. 1A shows that the diffracted image light 133 of the HOE 150 propagates in the x-z plane toward the out-coupling grating 145. In some embodiments, although not shown, the HOE 150 may be configured to expand the TIR propagating image light 131 in a first direction (e.g., a y-axis direction in FIG. 1A). For example, the diffracted image light 133 of the HOE 150 may be configured to propagate inside the light guide 110 in the y-z plane (not shown). The transmitted image light 135 may propagate inside the light guide 110 in the x-z plane. The diffracted image light 133 and the transmitted image light 135 may propagate to the out-coupling grating 145 via TIR. The out-coupling grating 145 may couple the diffracted image light 133 out of the light guide 110 as a plurality of output image lights arranged in the first direction (e.g., the y-axis direction), and couple the transmitted image light 135 out of the light guide 110 as a plurality of output image lights arranged in the second direction (e.g., the x-axis direction). Thus, a 2D expansion of the image light 130 may be provided at the output side of the light guide 110.

In the disclosed embodiments, the HOE 150 may include a volume grating having a series of periodic modulations of refractive index recorded in a volume of a suitable photo-sensitive material (or holographic material). The volume grating may be configured to substantially diffract an input light when the Bragg condition is substantially satisfied, and substantially transmit, with zero or negligible diffraction, an input light when the Bragg condition is not satisfied. Depending on the orientation of the modulation of the refractive index (or the orientation of the Bragg planes), the volume grating may be a transmissive or reflective volume grating. The volume gratings may be fabricated based on various methods, such as holographic interference, laser direct writing, ink-jet printing, and various other forms of lithography, for writing the series of periodic refractive index modulations in the volume of the photo-sensitive material.

Examples of photo-sensitive materials may include a silver halide emulsion, a dichromated gelatin, a photopolymer (e.g., photo-polymerizable monomers suspended in a polymer matrix), a photorefractive crystal, a birefringent medium with an intrinsic or induced (e.g., photo-induced) optical anisotropy (e.g., LCs, or a liquid crystal polymer, etc.), or a birefringent photo-refractive holographic material other than LCs, (e.g., an amorphous polymer, etc.), etc. Examples of volume gratings may include a volume holographic grating or volume Bragg grating, a polarization hologram grating based on liquid crystals (“LCs”), a polarization hologram grating based on a birefringent photo-refractive holographic material other than LCs, a polarization hologram grating based on sub-wavelength structures, etc. In some embodiments, the HOE 150 may include multiple holograms superimposed to broaden an angular range and/or a spectral range of the HOE 150.

In the disclosed embodiments, the HOE 150 may include a freeform volume grating (also referred to as 150 for discussion purposes). The freeform volume grating 150 may be a 1D grating or a 2D grating. The freeform volume grating 150 may be polarization selective or polarization non-selective. The optical responses of the freeform volume grating 150 (e.g., the spectral Bragg selectivity, the angular Bragg selectivity, and the diffraction efficiency, etc.) may be determined, in part, by various parameters of the freeform volume grating 150, such as a grating period, a slant or tilt angle of Bragg planes, a thickness, a birefringence, and/or a duty cycle, etc. In the disclosed embodiments, at least one parameter of the freeform volume grating 150 may be configured to vary along one or two dimensions in a film plane (e.g., the x-y plane shown in FIG. 1A) perpendicular to a thickness direction (e.g., the z-axis direction shown in FIG. 1A) of the freeform volume grating 150, such that at least one optical response of the freeform volume grating 150 may vary along one or two dimensions in the film plane of the freeform volume grating 150.

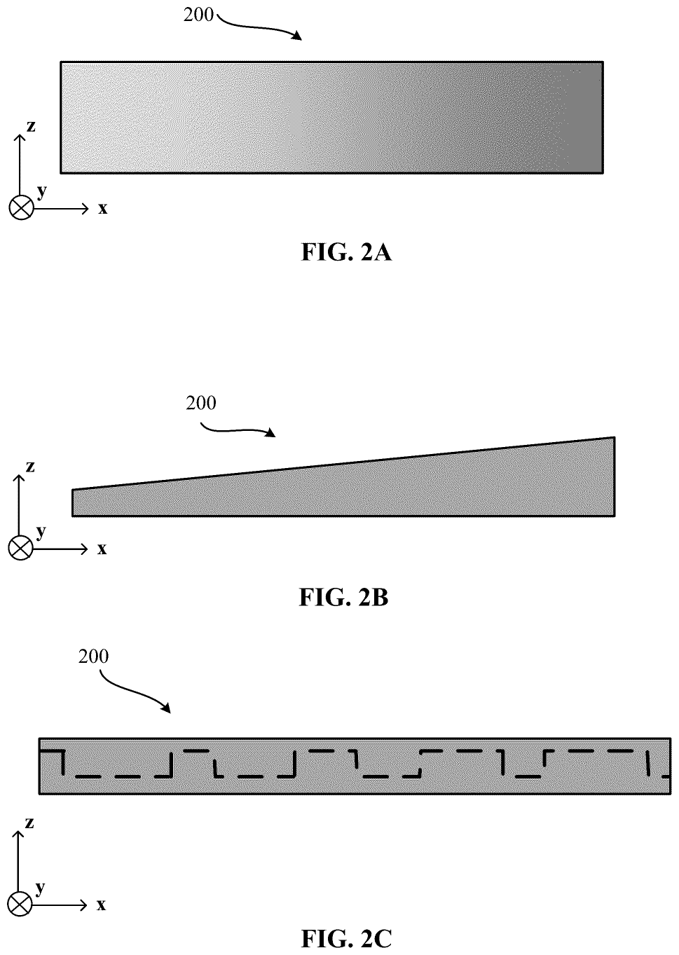

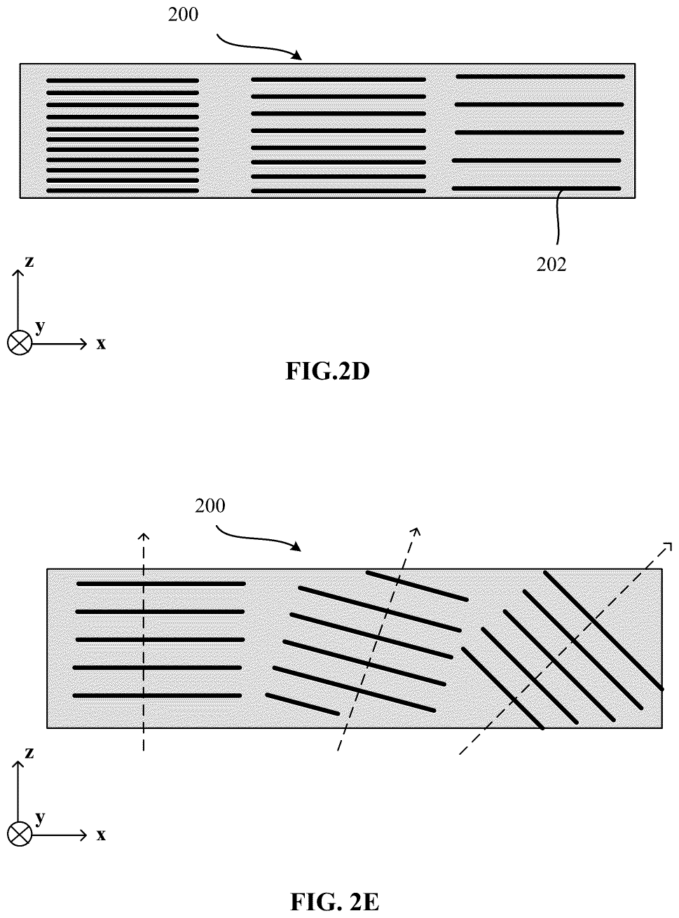

FIGS. 2A-2E illustrate parameter variations of a freeform volume grating 200 along one or two dimensions in the film plane of the freeform volume grating 200, according to various embodiments of the present discourse. The freeform volume grating 200 may be an embodiment of the freeform volume grating 150 shown in FIG. 1A. FIG. 2A illustrates that the freeform volume grating 200 is a freeform polarization hologram grating fabricated based on a birefringent medium, and the birefringence of the polarization hologram grating varies (e.g., increases) along the x-axis direction shown in FIG. 2A, in which the darker gray indicates a higher birefringence, and the lighter gray indicates a lower birefringence. The x-axis direction may be the same as the longitudinal direction of the light guide 110 shown in FIG. 1A, along which the TIR propagating light 131 propagates. FIG. 2B illustrates that the thickness of the freeform volume grating 200 varies (e.g., increases) along the x-axis direction shown in FIG. 2B.

FIG. 2C illustrates that the duty cycle of the freeform volume grating 200 varies (e.g., increases) along the x-axis direction shown in FIG. 2C. FIG. 2D illustrates that the grating period of the freeform volume grating 200 varies (e.g., increases) along the x-axis direction shown in FIG. 2D. Bragg planes 202 of the freeform volume grating 200 shown in FIG. 2D are represented by solid black lines. The orientation of the Bragg planes 202 shown in FIG. 2D are for illustrative purposes, and in some embodiments, the Bragg planes 202 may have another suitable orientation. FIG. 2E illustrates that the slant angle or tilt angle of the freeform volume grating 200 varies (e.g., increases) along the x-axis direction shown in FIG. 2E. The tilt angle is defined as an angle formed between a grating vector and the film plane of the freeform volume grating 200. The local grating vectors of the freeform volume grating 200 shown in FIG. 2E are represented by dashed arrows.

For discussion purposes, FIGS. 2A-2E show that a single parameter of the freeform volume grating 200 varies along a single direction in the film plane of the freeform volume grating 200. In some embodiments, different parameter variations shown in FIGS. 2A-2E may be combined in a single freeform volume grating 200. That is, the freeform volume grating 200 may have one or more parameters varying along one or two dimensions in the film plane of the freeform volume grating 200.

For example, in some embodiments, the grating period and/or the tilt angle of Bragg planes of the freeform volume grating 200 may be configured with a predetermined 1D or 2D variation along one or two dimensions in the film plane of the freeform volume grating 200, such that the freeform volume grating 200 has a predetermined 1D or 2D spectral Bragg selectivity variation and/or a predetermined 1D or 2D angular Bragg selectivity variation along one or two dimensions in the film plane of the freeform volume grating 200. In other words, as the grating period and/or the tilt angle of Bragg planes vary at different portions of the freeform volume grating 200, the spectral Bragg selectivity and/or the angular Bragg selectivity may vary at different portions of the freeform volume grating 200. That is, the Bragg wavelength and/or the Bragg angle may vary at different portions of the freeform volume grating 200. Thus, different portions of the freeform volume grating 200 may diffract input lights with different incidence angles and/or different incidence wavelengths.

For example, a first input light having a first predetermined incidence angle and a first predetermined incidence wavelength may satisfy the Bragg condition at a first portion of the freeform volume grating 200, and may not satisfy the Bragg condition at a second, different portion of the freeform volume grating 200. A second input light having a second predetermined incidence angle and a second predetermined incidence wavelength may not satisfy the Bragg condition at the first portion of the freeform volume grating 200, and may satisfy the Bragg condition at the second portion of the freeform volume grating 200. Thus, the first portion of the freeform volume grating 200 may diffract the first input light with a high diffraction efficiency, and transmit the second input light with zero or negligible diffraction. The second portion of the freeform volume grating 200 may diffract the second input light with a high diffraction efficiency, and transmit the first input light with zero or negligible diffraction.

In some embodiments, the thickness, the birefringence, and/or the duty cycle may be configured with a predetermined 1D or 2D variation along one or two dimensions in the film plane of the freeform volume grating 200, such that the freeform volume grating 200 has a predetermined 1D or 2D diffraction efficiency variation (e.g., for input lights with the same incidence angle, the same wavelength, the same polarization, etc.) along one or two dimensions in the film plane of the freeform volume grating 200. For example, in some embodiments, in the one or two dimensions in the film plane perpendicular to the thickness direction of the freeform volume grating 200, the thickness, the birefringence, and/or the duty cycle of the freeform volume grating 200 may decrease or increase in a gradient manner. The gradient manner may be a linearly gradient manner, a non-linearly gradient manner, a stepped gradient manner, or a suitable combination thereof. Accordingly, the diffraction efficiency may decrease or increase in a gradient manner.

In the embodiment shown in FIG. 1A, the freeform volume grating 150 disposed inside the light guide 110 may be configured to substantially maintain the TIR propagation angle 142 of the TIR propagating image light 131 inside the light guide 110, while diffracting or transmitting the TIR propagating image light 131. Thus, the diffracted image light 133 and the transmitted image light 135 may still propagate inside the light guide 110 toward the out-coupling grating 145 via TIR, with the same TIR propagation angle 142. FIG. 1B illustrates an x-z sectional view of the freeform volume grating 150 included in the light guide display assembly 100 shown in FIG. 1A, according to an embodiment of the present disclosure. For discussion purposes, the freeform volume grating 150 shown in FIG. 1B is a reflective volume grating.

As shown in FIG. 1B, Bragg planes (or grating lines) 152 (represented by solid black lines) inside the freeform volume grating 150 may be arranged substantially in parallel to the plane (e.g., the x-y plane shown in FIG. 1B) of the freeform volume grating 150, or substantially in parallel to the first surface 110-1 and the second surface 110-2 of the light guide 110 shown in FIG. 1A. Thus, a grating vector 154 (indicated by the dashed arrow) of the freeform volume grating 150 may be perpendicular to the film plane of the freeform volume grating 150. The Bragg condition of the freeform volume grating 150 shown in FIG. 1B may be defined as m*λ=2*Λ*sin(α), where λ is the incidence wavelength (or the Bragg wavelength), Λ is the grating period, m is a positive integer, and α is the Bragg angle that is an angle formed between an input light and the film plane of the freeform volume grating 150. The Bragg angle α and an incidence angle θ of the input light onto the freeform volume grating 150 may be complementary angles.

The grating period of the freeform volume grating 150 may be configured with a predetermined 1D or 2D variation along one or two dimensions in the film plane of the freeform volume grating 150. For discussion purposes, FIG. 1B shows that the grating period of the freeform volume grating 150 varies along a predetermined direction in the film plane of the freeform volume grating 150, e.g., decreasing in the +x-axis direction in FIG. 1B. According to the Bragg condition, as the grating period of the freeform volume grating 150 varies, the spectral and/or angular Bragg selectivity variation of the freeform volume grating 150 may vary in predetermined direction in the film plane of the freeform volume grating 150, e.g., in the x-axis direction in FIG. 1B.

FIGS. 1B-1E schematically illustrate spectral and/or angular Bragg selectivity variation of the freeform volume grating 150 included in the light guide display assembly 100 shown in FIG. 1A, according to various embodiments of the present discourse. The z-axis is the thickness direction of the freeform volume grating 150. FIG. 1B shows that a bundle of parallel rays (e.g., two parallel rays) 155 are incident onto different portions of the freeform volume grating 150, with the same incidence angle θ₁ and the same incidence wavelength λ₁. Due to the spectral and/or angular Bragg selectivity variation in the predetermined direction (e.g., the x-axis direction) in the film plane of the freeform volume grating 150, the parallel rays 155 with the same incidence angle θ₁ and the same incidence wavelength λ₁ may satisfy the Bragg condition at one or more portions of the freeform volume grating 150, and may not satisfy the Bragg condition outside of those portions.

For discussion purposes, FIG. 1B shows that the left ray 155 incident onto the left portion with a greater grating period substantially satisfies the Bragg condition and, thus, is diffracted as a ray 153. An angle formed by the diffracted ray 153 with respect to the film plane of the freeform volume grating 150 may also be α₁. The freeform volume grating 150 may also transmit a portion of the ray 155 as a transmitted order, e.g., a transmitted ray 156. FIG. 1B also shows that the right ray 155 incident onto the right portion with a smaller grating period may not satisfy the Bragg condition and, thus, is transmitted with zero or negligible diffraction. The freeform volume grating 150 may have a higher diffraction efficiency for the right ray 155 than for the left ray 155. In some embodiments, for the rays 155 incident onto respective portions of the freeform volume grating 150, the freeform volume grating 150 may be configured to exhibit a diffraction efficiency variation along the predetermined direction (e.g., the x-axis direction) in the film plane of the freeform volume grating 150.

FIG. 1C illustrates a diagram showing a spectral Bragg selectivity variation of the freeform volume grating 150, according to an embodiment of the present disclosure. A bundle (e.g., two) of parallel rays 155 and 165 may be incident onto the freeform volume grating 150, with the same incidence angle θ₁ and different incidence wavelengths λ₁ and λ₂. For example, the incidence wavelength λ₂ of the ray 165 may be shorter than the incidence wavelength λ₁ of the ray 155. For discussion purpose, FIG. 1C shows that at the left portion of the freeform volume grating 150 with a greater grating period, the ray 155 substantially satisfies the Bragg condition (similar to that shown in FIG. 1B) and, thus, is diffracted as the ray 153, and the ray 165 substantially does not satisfy the Bragg condition and, thus, is transmitted with zero or negligible diffraction.

For discussion purpose, FIG. 1C shows that at the right portion of the freeform volume grating 150 with a smaller grating period, the ray 165 incident substantially satisfies the Bragg condition and, thus, is diffracted as the ray 167. The diffracted ray 167 may form an angle α₁ with the film plane of the freeform volume grating 150, which may be the same as the angle α₁ formed between the diffracted ray 153 and the film plane of the freeform volume grating 150. The right portion of the freeform volume grating 150 may also transmit a portion of the ray 165 as a transmitted order, e.g., a transmitted ray 169. FIG. 1C also shows that at the right portion of the freeform volume grating 150 with a smaller grating period, the ray 155 may not satisfy the Bragg condition and, thus, is transmitted with zero or negligible diffraction. The diffraction efficiencies of the freeform volume grating 150 for the ray 155 incident onto the left portion and the ray 165 incident onto the right portion may be configured to be the same or different.

FIG. 1D illustrates a diagram showing an angular Bragg selectivity variation of the freeform volume grating 150, according to an embodiment of the present disclosure. A bundle (e.g., two) of rays 155 and 175 may be incident onto the freeform volume grating 150, with different incidence angles θ₁ and θ₂, and the same incidence wavelengths λ₁. For example, the incidence angle θ₂ of the ray 175 may be greater than the incidence angle θ₁ of the ray 155. For discussion purpose, FIG. 1D shows that at the left portion of the freeform volume grating 150 with a greater grating period, the ray 155 substantially satisfies the Bragg condition and, thus, is diffracted as the ray 153, and the ray 175 does not satisfy the Bragg condition and, thus, is transmitted with zero or negligible diffraction.

For discussion purpose, FIG. 1D shows that at the right portion of the freeform volume grating 150 with a smaller grating period, the ray 175 substantially satisfies the Bragg condition and, thus, is diffracted as a ray 177. The diffracted ray 177 may form an angle α₂ with the film plane of the freeform volume grating 150. For example, the angle α₂ may be smaller than the angle α₁ formed between the diffracted ray 153 and the film plane of the freeform volume grating 150. The freeform volume grating 150 may also transmit a portion of the ray 175 as a transmitted order, e.g., a transmitted ray 179. FIG. 1D shows that at the right portion of the freeform volume grating 150 with a smaller grating period, the ray 155 does not satisfy the Bragg condition and, thus, is transmitted with zero or negligible diffraction. The diffraction efficiencies of the freeform volume grating 150 for the ray 155 incident onto the left portion and the ray 175 incident onto the right portion may be configured to be the same or different.

FIG. 1E illustrates a diagram showing both of a spectral Bragg selectivity variation and an angular Bragg selectivity variation of the freeform volume grating 150, according to an embodiment of the present disclosure. A bundle (e.g., two) of rays 155 and 185 may be incident onto the freeform volume grating 150 with different incidence angles θ₁ and θ₃, and different incidence wavelengths λ₁ and λ₃. For example, the incidence wavelength λ₃ of the ray 185 may be shorter than the incidence wavelength λ₁ of the ray 155, and the incidence angle θ₃ of the ray 185 may be greater than the incidence angle θ₁ of the ray 155. For discussion purpose, FIG. 1E shows that at the left portion of the freeform volume grating 150 with a greater grating period, the ray 155 substantially satisfies the Bragg condition and, thus, is diffracted as the ray 153, and the ray 185 does not satisfy the Bragg condition and, thus, is transmitted with zero or negligible diffraction.

For discussion purpose, FIG. 1E shows that at the right portion of the freeform volume grating 150 with a smaller grating period, the ray 185 substantially satisfies the Bragg condition and, thus, is diffracted as a ray 187. The diffracted ray 187 may form an angle α₃ with the film plane of the freeform volume grating 150. For example, the angle α₃ may be smaller than the angle α₁ formed between the diffracted ray 153 and the film plane of the freeform volume grating 150. The freeform volume grating 150 may also transmit a portion of the ray 185 as a transmitted order, e.g., a transmitted ray 189. FIG. 1E also shows that at the right portion of the freeform volume grating 150 with a smaller grating period, the ray 155 does not satisfy the Bragg condition and, thus, is transmitted with zero or negligible diffraction. The diffraction efficiencies of the freeform volume grating 150 for the ray 155 and the ray 185 may be configured to be the same or different.

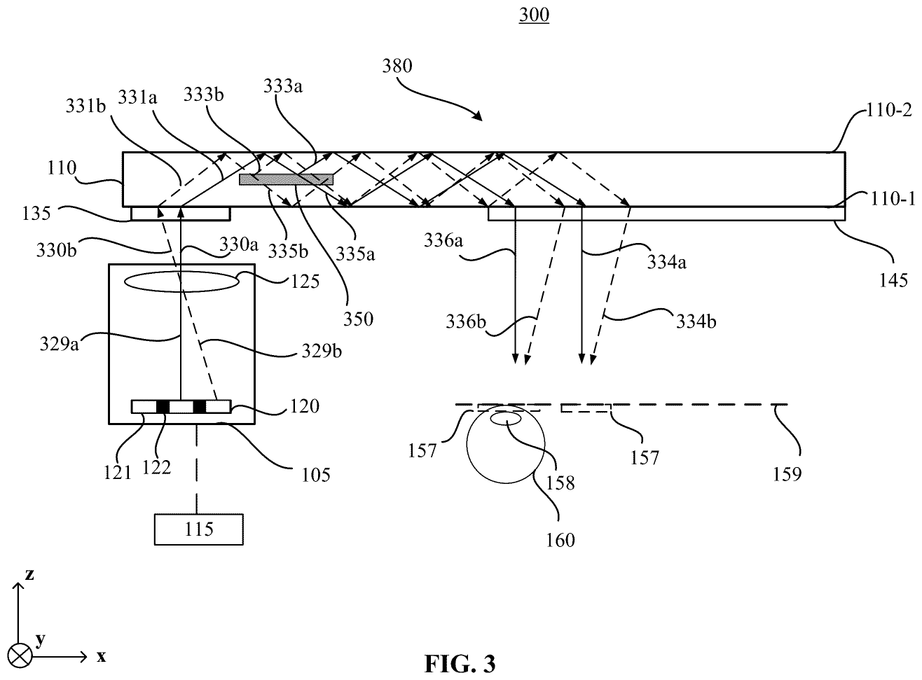

FIG. 3 illustrates a schematic diagram of a light guide display system or assembly 300, according to an embodiment of the present disclosure. The light guide display system 300 may include elements that are similar to or the same as those included in the light guide display system 100 shown in FIGS. 1A-1F. Descriptions of the same or similar elements or features can refer to the above corresponding descriptions, including those rendered in connection with FIGS. 1A-1F. As shown in FIG. 3, the light guide display system 300 may include the controller 115, the light source assembly 105, the light guide 110, the in-coupling element (or input coupler) 135 coupled with the light guide 110 at the input portion of the light guide 110, and the out-coupling element (or output coupler) 145 coupled with the light guide 110 at the output portion of the light guide 110.

The light guide display system 300 may also include a freeform volume grating 350 disposed between the input portion and the output portion of the light guide 110. For example, in some embodiments, the freeform volume grating 350 may be disposed entirely inside (or embedded in) the light guide 110 between the input portion and the output portion of the light guide 110. The freeform volume grating 350 may be similar to the freeform volume grating 150 shown in FIGS. 1A-1F, or the freeform volume grating 200 shown in FIGS. 2A-2E. The combination of the light guide 110, the input coupler 135, the output coupler 145, and the freeform volume grating 350 may also be referred to as a light guide image combiner 380.

In the embodiment shown in FIG. 3, the freeform volume grating 350 may be configured with an angular Bragg selectivity variation to provide a predetermined angular illuminance distribution and/or a predetermined spatial illuminance distribution at the output side of the light guide 110. For illustrative purposes, FIG. 3 shows that a first image ray 329a and a second image ray 329b are output from two different pixels 121 of the display element 120, e.g. the central pixel 121 and the right pixel 121. The first image ray 329a and the second image ray 329b may have the same wavelength. The collimating lens 125 may convert the respective rays 329a and 329b into a first input ray 330a representing a first FOV direction of the input FOV, and a second input ray 330b representing a second, different FOV direction of the input FOV.

The input coupler 135 may couple the first input ray 330a and the second input ray 330b into the light guide 110 as a first in-coupled ray 331a having a first TIR propagation angle (also referred to as a first TIR propagating ray 331a), and a second in-coupled ray 331b having a second, different TIR propagation angle (also referred to as a second TIR propagating ray 331b), respectively. For example, FIG. 3 shows that the first TIR propagation angle is greater than the second TIR propagation angle. The first TIR propagating ray 331a and the second TIR propagating ray 331b may propagate inside the light guide 110 toward the freeform volume grating 350 via TIR. For discussion purposes, the freeform volume grating 350 may have a grating period variation similar to that shown in FIG. 1D, and may exhibit an angular Bragg selectivity variation similar to that shown in FIG. 1D.

The first TIR propagating ray 331a and the second TIR propagating ray 331b may be incident onto different portions of the freeform volume grating 350 with the same wavelength and different incidence angles, e.g., a right portion (e.g., with a shorter grating period) and a left portion (e.g., with a greater grating period) respectively. For example, FIG. 3 shows that the incidence angle of the first TIR propagating ray 331a is greater than the incidence angle of the second TIR propagating ray 331b. For illustrative purposes, FIG. 3 shows that the grating period variation of the freeform volume grating 350 is configured, such that the second TIR propagating ray 331b may substantially satisfy the Bragg condition when incident onto the left portion (e.g., with the greater grating period), and may not satisfy the Bragg condition when incident onto the right portion (e.g., with the shorter grating period). The first TIR propagating ray 331a may not satisfy the Bragg condition when incident onto the left portion (e.g., with the greater grating period), and may satisfy the Bragg condition when incident onto the right portion (e.g., with the shorter grating period).

As shown in FIG. 3, as the second TIR propagating ray 331b substantially satisfies the Bragg condition when incident onto the left portion (e.g., with the greater grating period) of the freeform volume grating 350, the second TIR propagating ray 331b may be backwardly diffracted as a ray 333b. The angle formed by the diffracted ray 333b with respect to the film plane of the freeform volume grating 350 may be the same as the angle formed by the second TIR propagating ray 331b with respect to the film plane of the freeform volume grating 350. The left portion (e.g., with the greater grating period) of the freeform volume grating 350 may also transmit a portion of the second TIR propagating ray 331b as a transmitted order, e.g., a ray 335b. The efficiencies of the freeform volume grating 350 for the ray 333b and the ray 335b may be configured to be the same or different.

The ray 333b and the ray 335b may propagate inside the light guide 110 via TIR, with the first TIR propagation angle. In some embodiments, the ray 333b and the ray 335b may be incident onto the freeform volume grating 350 again, e.g., onto the right portion (e.g., with the smaller grating period). The ray 333b and the ray 335b may not satisfy the Bragg condition at the right portion of the freeform volume grating 350 and, thus, may be transmitted with zero or negligible diffraction. Then the ray 333b and the ray 335b may propagate inside the light guide 110 toward the output coupler 145 via TIR. The output coupler 145 may couple the ray 333b and the ray 335b output of the light guide 110 as an output ray 334b and an output ray 336b, respectively. The output ray 334b and the output ray 336b may represent the same FOV direction of the output FOV, e.g., a second FOV direction.

As the first TIR propagating ray 331a substantially satisfies the Bragg condition when incident onto the right portion (e.g., with the smaller grating period) of the freeform volume grating 350, the first TIR propagating ray 331a may be backwardly diffracted as a ray 333a. The angle formed by the diffracted ray 333a with respect to the film plane of the freeform volume grating 350 may be the same as the angle formed by the first TIR propagating ray 331a with respect to the film plane of the freeform volume grating 350. The right portion (e.g., with the smaller grating period) of the freeform volume grating 350 may also transmit a portion of the first TIR propagating ray 331a as a transmitted order, e.g., a ray 335a. The efficiencies of the freeform volume grating 350 for the ray 333a and ray 335a may be configured to be the same or different. Then the ray 333a and the ray 335a may propagate inside the light guide 110 toward the output coupler 145 via TIR. The output coupler 145 may couple the ray 333a and the ray 335a output of the light guide 110 as an output ray 334a and an output ray 336a, respectively. The output ray 334a and the output ray 336a may represent the same FOV direction of the output FOV, e.g., a first FOV direction.

In the embodiment shown in FIG. 3, the grating period variation of the freeform volume grating 350 may be configured, such that the respective diffraction efficiencies of the freeform volume grating 350 for the diffracted ray 333b and diffracted ray 333a may be desirable diffraction efficiencies, and the respective transmission efficiencies of the freeform volume grating 350 for the transmitted ray 335b and diffracted ray 335a may be desirable diffraction efficiencies. Thus, the respective light intensities of the diffracted ray 333b, the transmitted ray 335b, the diffracted ray 333a, and the transmitted ray 335a may be controlled. Accordingly, the respective light intensities of the output ray 334b, the output ray 336b, the output ray 334a, and the output ray 336a may be controlled.

For example, through configuring the grating period variation of the freeform volume grating 350, the respective diffraction efficiencies of the freeform volume grating 350 for the diffracted ray 333b and diffracted ray 333a may be controlled, such that the output ray 334b and the output ray 334a have respective desirable light intensities. As the output ray 334a and the output ray 334b represent different FOV directions of the output FOV (e.g., the first FOV direction and the second FOV direction, respectively), desirable angular illuminances of the first FOV direction and the second FOV direction may be achieved. For example, in some embodiments, the respective diffraction efficiencies of the freeform volume grating 350 for the diffracted ray 333b and the diffracted ray 333a may be substantially the same. Thus, the output ray 334a and the output ray 334b may have substantially the same light intensity. As a result, the uniformity of the angular illuminance distribution at the output side of the light guide 110 may be improved.

Similarly, through configuring the grating period variation of the freeform volume grating 350, transmission efficiencies of the freeform volume grating 350 for the transmitted ray 335b and the transmitted ray 335a may be controlled, such that the output ray 336b and the output ray 336a may have respective desirable light intensities. As the output ray 336a and the output ray 336b represent different FOV directions of the output FOV (e.g., the first FOV direction and the second FOV direction, respectively), desirable angular illuminances of the first FOV direction and the second FOV direction may be achieved. For example, in some embodiments, the respective transmission efficiencies of the freeform volume grating 350 for the transmitted ray 335b and the transmitted ray 335a may be configured to be substantially the same. Thus, the output ray 336a and the output ray 336b may have substantially the same light intensity. As a result, the uniformity of the angular illuminance distribution at the output side of the light guide 110 may be improved.

In some embodiments, through configuring the grating period variation of the freeform volume grating 350, the diffraction efficiency and the transmission efficiency of the freeform volume grating 350 for the diffracted ray 333b and transmitted ray 335b may be controlled. Thus, the output ray 334b and the output ray 336b may have respective desirable light intensities. As the output ray 336b and the output ray 334b are coupled out of the light guide 110 at different portions of the light guide 110, desirable spatial illuminances of the output ray 336b and the output ray 334b may be achieved. For example, in some embodiments, the diffraction efficiency and the transmission efficiency of the freeform volume grating 350 for the diffracted ray 333b and transmitted ray 335b may be configured to be substantially the same, e.g., the diffraction efficiency and the transmission efficiency may be 50% and 50%, respectively. In such an embodiment, the output ray 336b and the output ray 334b may have substantially the same light intensity. Thus, the uniformity of the spatial illuminance distribution at the output side of the light guide 110 may be improved.

Similarly, through configuring the grating period variation of the freeform volume grating 350, the diffraction efficiency and the transmission efficiency of the freeform volume grating 150 for the diffracted ray 333a and transmitted ray 335a may be controlled, such that the output ray 334a and the output ray 336a may have respective desirable light intensities. As the output ray 336a and the output ray 334a are coupled out of the light guide 110 at different portions of the light guide 110, desirable spatial illuminances of the output ray 336a and the output ray 334a may be achieved. For example, in some embodiments, the diffraction efficiency and the transmission efficiency of the freeform volume grating 350 for the diffracted ray 333a and transmitted ray 335a may be configured to be substantially the same, e.g., the diffraction efficiency and the transmission efficiency may be 50% and 50%, respectively. In such an embodiment, the output ray 336a and the output ray 334a may have the same light intensity. Thus, the uniformity of the spatial illuminance distribution at the output side of the light guide 110 may be improved.

For discussion purposes, FIG. 3 shows that the freeform volume grating 350 has a 1D grating period variation along the x-axis direction, and a 1D angular illuminance distribution and/or spatial illuminance distribution at the output side of the light guide 110 may be achieved. A 2D angular illuminance distribution and/or spatial illuminance distribution at the output side of the light guide 110 may be provided by the light guide display system 300 following the same or similar principles described above. Through configuring the freeform volume grating 350 with a predetermined 1D or 2D grating period variation in the one or two dimensions in the film plane of the freeform volume grating 350, a predetermined 1D or 2D angular illuminance distribution and/or a predetermined 1D or 2D spatial illuminance distribution at the output side of the light guide 110 may be achieved. The predetermined 1D or 2D spatial and/or angular illuminance distribution may be a uniform spatial and/or angular illuminance distribution, or a controlled, pre-configured non-uniform spatial and/or angular illuminance distribution, depending on the specific application scenarios.

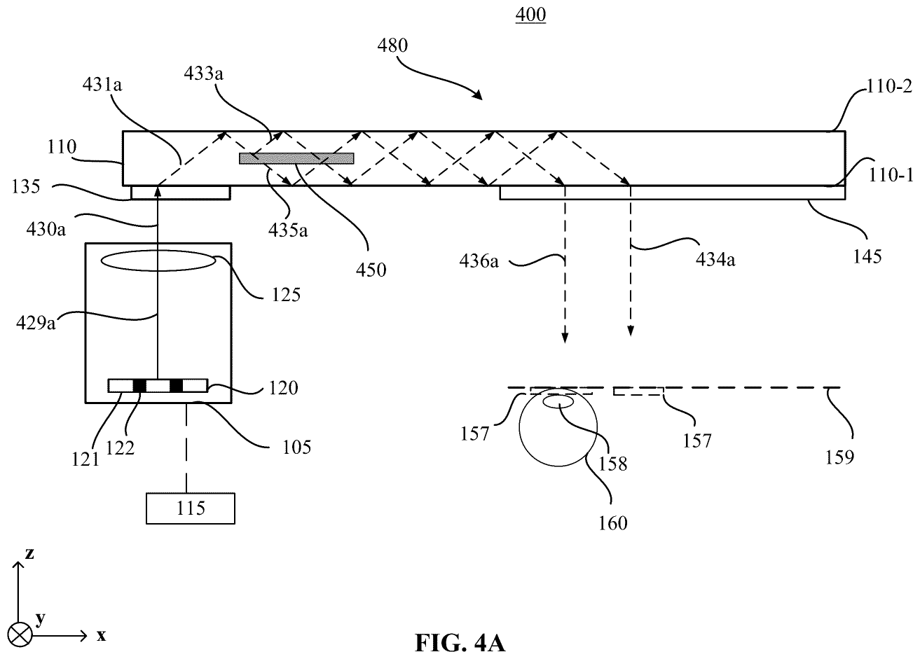

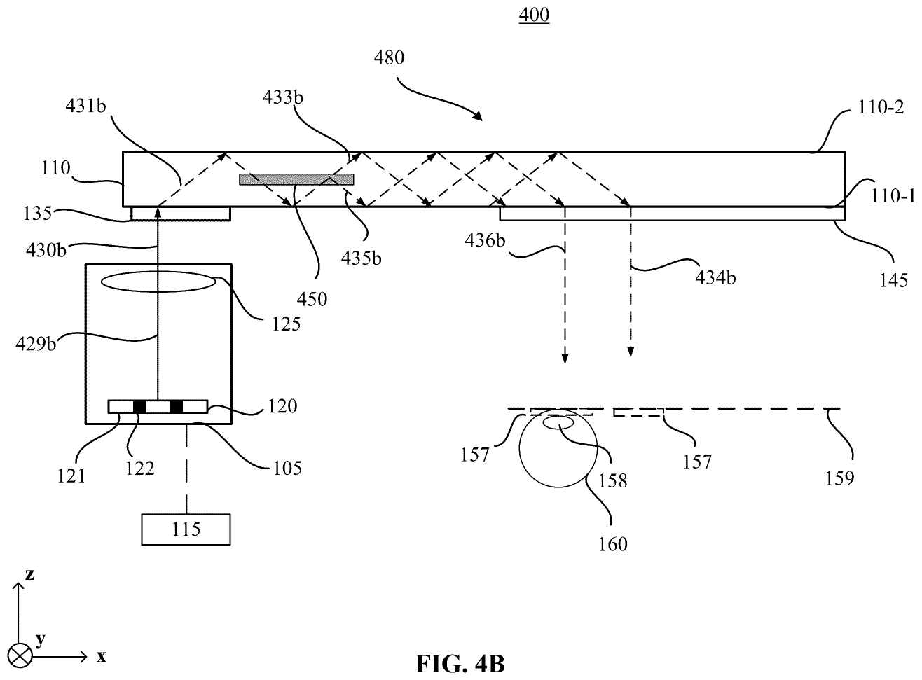

FIGS. 4A and 4B illustrate a schematic diagram of a light guide display system or assembly 400, according to an embodiment of the present disclosure. The light guide display system 400 may include elements that are similar to or the same as those included in the light guide display system 100 shown in FIGS. 1A-1F, or the light guide display system 300 shown in FIG. 3. Descriptions of the same or similar elements or features can refer to the above corresponding descriptions, including those rendered in connection with FIGS. 1A-1F or FIG. 3.

As shown in FIG. 4A, the light guide display system 400 may include the controller 115, the light source assembly 105, the light guide 110, the in-coupling element (or input coupler) 135 coupled with the light guide 110 at the input portion of the light guide 110, and the out-coupling element (or output coupler) 145 coupled with the light guide 110 at the output portion of the light guide 110. The light guide display system 400 may also include a freeform volume grating 450 disposed between the input portion and the output portion of the light guide 110. For example, in some embodiments, the freeform volume grating 350 may be disposed entirely inside (or embedded in) the light guide 110 between the input portion and the output portion of the light guide 110. The freeform volume grating 450 may be similar to the freeform volume grating 150 shown in FIGS. 1A-1F, or the freeform volume grating 200 shown in FIGS. 2A-2E. The combination of the light guide 110, the input coupler 135, the output coupler 145, and the freeform volume grating 450 may also be referred to as a light guide image combiner 480.

In the embodiment shown in FIG. 4A, the freeform volume grating 450 is configured with a spectral Bragg selectivity variation to provide a predetermined angular illuminance distribution and/or a predetermined spatial illuminance distribution at the output side of the light guide 110. For illustrative purposes, FIGS. 4A and 4B show that two parallel image rays, e.g., a first image ray 429a and a second image ray 429b, are output from the same pixel (e.g. the central pixel) 121 of the display element 120 at the same or different time instances. FIG. 4A illustrates the optical path of the first image ray 429a inside the system 400, and FIG. 4B illustrates the optical path of the second image ray 429b inside the system 400. Referring to FIGS. 4A and 4B, the first image ray 429a and the second image ray 429b may have different wavelengths, e.g., the first image ray 429a may be a red image ray, and the second image ray 429b may be a blue image ray. The collimating lens 125 may convert the respective rays 429a and 429b into a first input ray 430a and a second input ray 430b representing the same FOV direction of an input FOV, e.g., the zero-degree FOV direction.

The input coupler 135 may couple the first input ray 430a and the second input ray 430b into the light guide 110 as a first in-coupled ray 431a having a first TIR propagation angle (also referred to as a first TIR propagating ray 431a), and a second in-coupled ray 431b having a second TIR propagation angle (also referred to as a second TIR propagating ray 431b), respectively. The first TIR propagation angle may be equal to the second TIR propagation angle. The first TIR propagating ray 431a and the second TIR propagating ray 431b may propagate inside the light guide 110 toward the freeform volume grating 450 via TIR. For discussion purposes, the freeform volume grating 450 may have a grating period variation, and may exhibit a spectral Bragg selectivity variation similar to that shown in FIG. 1C.

As shown in FIGS. 4A and 4B, the first TIR propagating ray 431a and the second TIR propagating ray 431b may be incident onto a left portion (e.g., with a greater grating period) of the freeform volume grating 450. For illustrative purposes, FIGS. 4A and 4B show that the grating period variation of the freeform volume grating 450 may be configured, such that first TIR propagating ray 431a may substantially satisfy the Bragg condition when incident onto the left portion (e.g., with the greater grating period), and may not satisfy the Bragg condition when incident onto the right portion (e.g., with a shorter grating period). The second TIR propagating ray 431b may not satisfy the Bragg condition when incident onto the left portion (e.g., with the greater grating period), and may satisfy the Bragg condition when incident onto the right portion (e.g., with the shorter grating period).

As shown in FIG. 4A, as the first TIR propagating ray 431a substantially satisfies the Bragg condition when incident onto the left portion (e.g., with the greater grating period) of the freeform volume grating 450, the first TIR propagating ray 431a may be diffracted as a ray 433a. The angle formed by the diffracted ray 433b with respect to the film plane of the freeform volume grating 450 may be the same as the angle formed by the first TIR propagating ray 431a with respect to the film plane of the freeform volume grating 450. The left portion (e.g., with the greater grating period) of the freeform volume grating 450 may also transmit a portion of the first TIR propagating ray 431a as a transmitted order, e.g., a ray 435a. The efficiencies of the freeform volume grating 450 for the ray 433a and the ray 435a may be configured to be the same or different.

The ray 433a and the ray 435a may propagate inside the light guide 110 via TIR, with the first TIR propagation angle. In some embodiments, the ray 433a and the ray 435a may be incident onto the freeform volume grating 450 again, e.g., onto the right portion (e.g., with the smaller grating period). The ray 433a and the ray 435a may not satisfy the Bragg condition at the right portion of the freeform volume grating 450 and, thus, may be transmitted with zero or negligible diffraction. Then the ray 433a and the ray 435a may propagate inside the light guide 110 toward the output coupler 145 via TIR. The output coupler 145 may respectively couple the ray 433a and the ray 435a output of the light guide as an output ray 434a and an output ray 436a, at different portions of the light guide 110. The output ray 434a and the output ray 436a may represent the same FOV direction of the output FOV, e.g., the zero-degree FOV direction.

As shown in FIG. 4B, the second TIR propagating ray 431b may not satisfy the Bragg condition when incident onto the left portion of the freeform volume grating 450, and thus, the second TIR propagating ray 431b may be transmitted by the left portion with zero or negligible diffraction. The second TIR propagating ray 431b may be incident onto the freeform volume grating 450 again, e.g., onto the right portion (e.g., with the smaller grating period). The second TIR propagating ray 431b substantially satisfies the Bragg condition when incident onto the right portion (e.g., with the smaller grating period) of the freeform volume grating 450, and thus, the second TIR propagating ray 431b may be diffracted by the right portion as a ray 433b. The angle formed by the diffracted ray 43ba with respect to the film plane of the freeform volume grating 450 may be the same as the angle formed by the second TIR propagating ray 431b with respect to the film plane of the freeform volume grating 450. The right portion (e.g., with the smaller grating period) of the freeform volume grating 450 may also transmit a portion of the second TIR propagating ray 431b as a transmitted order, e.g., a ray 435b.

The efficiencies of the freeform volume grating 450 for the ray 433b and the ray 435b may be configured to be the same or different. Then the ray 433b and the ray 435b may propagate inside the light guide 110 toward the output coupler 145 via TIR. The output coupler 145 may respectively couple the ray 433b and the ray 435b output of the light guide 110 as an output ray 434b and an output ray 436b, at different portions of the light guide 110. The output ray 434b and the output ray 436b may represent the same FOV direction of the output FOV, e.g., the zero-degree FOV direction. Referring to FIGS. 4A and 4B, the output ray 434a (e.g., red ray) may substantially overlap with the output ray 434b (e.g., blue ray), and output ray 436a (e.g., red ray) may substantially overlap with the output ray 436b (e.g., blue ray).

In the embodiment shown in FIGS. 4A and 4B, the grating period variation of the freeform volume grating 450 may be configured, such that the respective diffraction efficiencies of the freeform volume grating 450 for the diffracted ray 433a and diffracted ray 433b may be controlled to provide respective desirable transmission efficiencies for the transmitted ray 435a and diffracted ray 435b. Thus, the respective light intensities of the diffracted ray 433a, the transmitted ray 435a, the diffracted ray 433b, and the transmitted ray 435b may be configured. Accordingly, the respective light intensities of the output ray 434a, the output ray 436a, the output ray 434b, and the output ray 436b may be configured.

For example, through configuring the grating period variation of the freeform volume grating 450, the freeform volume grating 450 may provide desirable diffraction efficiency and the transmission efficiency for the diffracted ray (e.g., red ray) 433a and the transmitted ray (e.g., red ray) 435a. Thus, the output ray 434a and the output ray 436a may be configured with respective desirable light intensities. As the output ray 436a and the output ray 434a are coupled out of the light guide 110 at different portions of the light guide 110, desirable spatial illuminances of the output ray 436a and the output ray 434a may be achieved. For example, in some embodiments, the diffraction efficiency and the transmission efficiency of the freeform volume grating 450 for the diffracted ray 433a and transmitted ray 435a may be configured to be substantially the same, e.g., the diffraction efficiency and the transmission efficiency may be 50% and 50%, respectively. In such an embodiment, the output ray 436a and the output ray 434a may have the same light intensity. Thus, the uniformity of the spatial illuminance distribution at the output side of the light guide 110 may be improved.

Similarly, through configuring the grating period variation of the freeform volume grating 450, the freeform volume grating 450 may provide desirable diffraction efficiency and the transmission efficiency for the diffracted ray (e.g., blue ray) 433b and the transmitted ray (e.g., blue ray) 435b. Thus, the output ray 434a and the output ray 436a may be configured with respective desirable light intensities. As the output ray 436b and the output ray 434b are coupled out of the light guide 110 at different portions of the light guide 110, desirable spatial illuminances of the output ray 436b and the output ray 434b may be achieved. For example, in some embodiments, the diffraction efficiency and the transmission efficiency of the freeform volume grating 450 for the diffracted ray 433b and transmitted ray 435b may be configured to be substantially the same, e.g., the diffraction efficiency and the transmission efficiency may be 50% and 50%, respectively. In such an embodiment, the output ray 436b and the output ray 434b may have the same light intensity. Thus, the uniformity of the spatial illuminance distribution at the output side of the light guide 110 may be improved.

In some embodiments, through configuring the grating period variation of the freeform volume grating 450, the freeform volume grating 450 may provide respective desirable diffraction efficiencies for the diffracted ray (e.g., red ray) 433a and diffracted ray (e.g., blue ray) 433b. Thus, the output ray 434a and the output ray 434b may be configured to have respective desirable light intensities. As the output ray 434a and the output ray 434b have different wavelengths, desirable spectral illuminances in the two different wavelengths may be achieved. Similarly, through configuring the grating period variation of the freeform volume grating 450, the respective transmission efficiencies of the freeform volume grating 450 for the transmitted ray 435a and the transmitted ray 435b may be configured. Thus, the output ray 436a and the output ray 436b may be configured to have respective desirable light intensities. As the output ray 436a and the output ray 436b have different wavelengths, desired spectral illuminances in the two different wavelengths may be achieved.

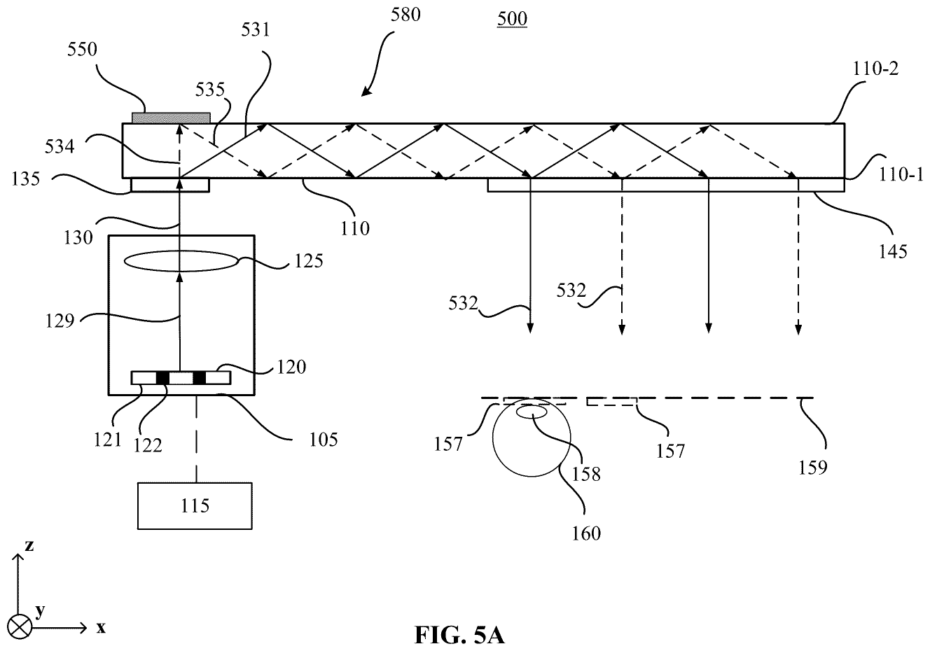

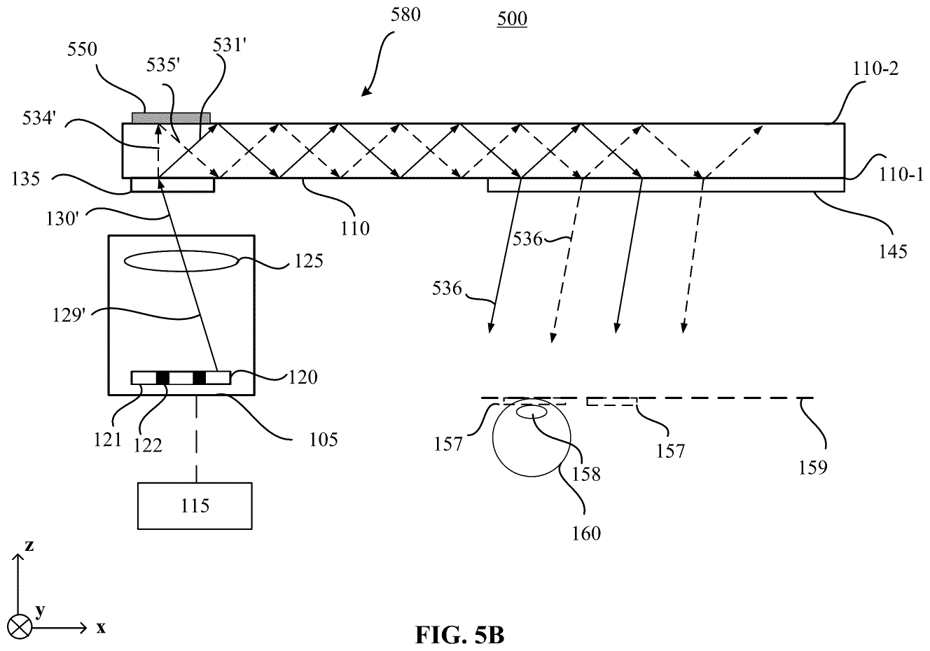

FIGS. 5A and 5B illustrate a schematic diagram of a light guide display system or assembly 500, according to an embodiment of the present disclosure. The light guide display system 500 may include elements that are similar to or the same as those included in the light guide display system 100 shown in FIGS. 1A-1F, the light guide display system 300 shown in FIG. 3, or the light guide display system 400 shown in FIGS. 4A and 4B. Descriptions of the same or similar elements or features can refer to the above corresponding descriptions, including those rendered in connection with FIGS. 1A-1F, FIG. 3, or FIGS. 4A and 4B.

As shown in FIG. 5A, the light guide display system 500 may include the controller 115, the light source assembly 105, the light guide 110, the in-coupling element (or input coupler) 135 coupled with the light guide 110 at the input portion of the light guide 110, and the out-coupling element (or output coupler) 145 coupled with the light guide 110 at the output portion of the light guide 110. The light guide display system 500 may also include a freeform volume grating 550 coupled with the light guide 110 at the input portion of the light guide 110. The freeform volume grating 550 may be similar to the freeform volume grating 150 shown in FIGS. 1A-1F, or the freeform volume grating 200 shown in FIGS. 2A-2E. The combination of the light guide 110, the input coupler 135, the output coupler 145, and the freeform volume grating 550 may also be referred to as a light guide image combiner 580.

In some embodiments, the freeform volume grating 550 may be formed or disposed at (e.g., affixed to) the first surface 110-1 or the second surface 110-2 of the light guide 110. In some embodiments, the freeform volume grating 550 may be integrally formed as a part of the light guide 110, or may be a separate element coupled to the light guide 110. In some embodiments, the freeform volume grating 550 may be directly disposed onto or formed at the first surface 110-1 or the second surface 110-2. In some embodiments, the freeform volume grating 550 may be disposed adjacent the first surface 110-1 or the second surface 110-2 with a gap.

The freeform volume grating 550 may be substantially aligned with the input coupler 135 in the thickness direction (e.g., z-axis direction) of the light guide 110. In some embodiments, as shown in FIG. 5A, the freeform volume grating 550 and the input coupler 135 may be formed or disposed at (e.g., affixed to) different surfaces of the light guide 110, and the freeform volume grating 550 may be disposed opposite to the input coupler 135. In some embodiments, although not shown, the freeform volume grating 550 and the input coupler 135 may be formed or disposed at (e.g., affixed to) the same surface of the light guide 110. For example, the freeform volume grating 550 may be disposed between the input coupler 135 and the light guide 110.

The input coupler 135 may be configured to couple a first portion of the input image light 130 into the light guide 110 as a first in-coupled image light 531 (also referred to as a first TIR propagating image light 531), and also transmit a second portion of the input image light 130 as an image light 534 that may be transmitted through the light guide 110 toward the freeform volume grating 550. That is, the image light 534 may not be coupled into the light guide 110 as an in-coupled (or TIR propagating) image light. The freeform volume grating 550 may be configured to couple, via diffraction, the image light 534 back into the light guide 110, as a second in-coupled image light 535 (also referred to as a second TIR propagating image light 535) having the same TIR propagation angle as the first TIR propagating image light 531. Thus, the first TIR propagating image light 531 and the second TIR propagating image light 535 may propagate inside the light guide 110 via TIR toward the output coupler 145. The output coupler 145 may couple the first TIR propagating image light 531 and the second TIR propagating image light 535 out of the light guide 110 as a plurality of first output image lights 532 each having a first output angle.

Without the freeform volume grating 550, the image light 534 that is not coupled into the light guide 110 would otherwise be transmitted out of the light guide 110 to the real world environment in a conventional light guide display system. As a result, light intensity is reduced. With the freeform volume grating 550, the image light 534 is recycled back into the light guide 110, the optical efficiency at the input side of the light guide 110 (or the input efficiency of the input coupler 135) is increased. Accordingly, the power efficiency of the light guide display system 500 may be increased. In addition, the number of the exit pupils 157 within the same eye-box region 159 may be increased.

In some embodiments, through configuring the freeform volume grating 550, e.g., configuring at least one of a predetermined 1D or 2D grating period variation or a predetermined slant angle variation in the one or two dimensions in the film plane of the freeform volume grating 550, the light guide display system 500 may provide a predetermined 1D or 2D angular illuminance distribution and/or spatial illuminance distribution at the output side of the light guide 110, following the same or similar principles in connection with FIGS. 3-4B. For example, the input image light 130 shown in FIG. 5A may be referred to as a first input image light having a first incidence angle, and the first in-coupled image light 531 and the second in-coupled image light 535 may have a same first TIR propagation angle. FIG. 5B shows the light source assembly 105 may also output a second input image light 130′ having a second, different incidence angle toward the input coupler 135. The first input image light 130 and the second input image light 130′ may have the same incidence wavelength. The first input image light 130 and the second input image light 130′ may be incident onto different portions of the input coupler 135. The first input image light 130 and the second input image light 130′ may represent different FOV directions of an input FOV.

As shown in FIG. 5B, the input coupler 135 may couple a first portion of the second input image light 130′ as a third in-coupled image light 531′ having a second, different TIR propagation angle, and transmit a second portion of the second input image light 130′ as an image light 534′ toward the freeform volume grating 550. The freeform volume grating 550 may couple, via diffraction, the image light 534′ back into the light guide 110, as a fourth in-coupled image light 535′ having the second TIR propagation angle. The output coupler 145 may couple the third in-coupled image light 531′ and the fourth in-coupled image light 535′ out of the light guide 110 as a plurality of second output image lights 536 having a second, different output angle.

In some embodiments, the diffraction efficiencies of the freeform volume grating 550 for the image light 534′ shown in FIG. 5A and the image light 534′ shown in FIG. 5B may be configured, such that the light guide display system 500 may provide a predetermined 1D or 2D angular illuminance distribution (e.g., uniform angular illuminance distribution) at the output side of the light guide 110. For example, the first output image lights 532 and the second output image lights 536 may provide a predetermined 1D or 2D angular or spatial illuminance distribution (e.g., unfirm angular or spatial illuminance distribution) at the output side of the light guide 110.

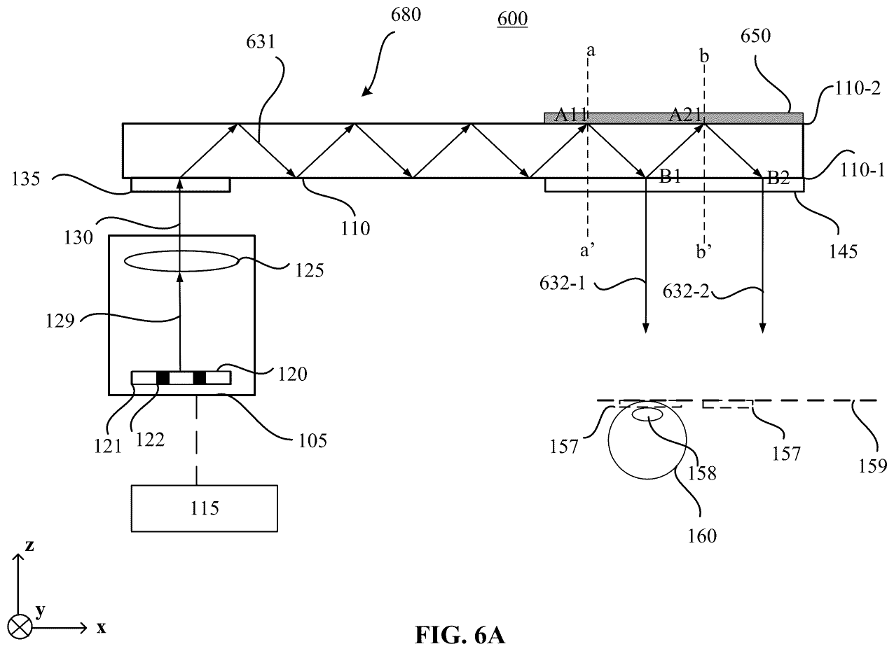

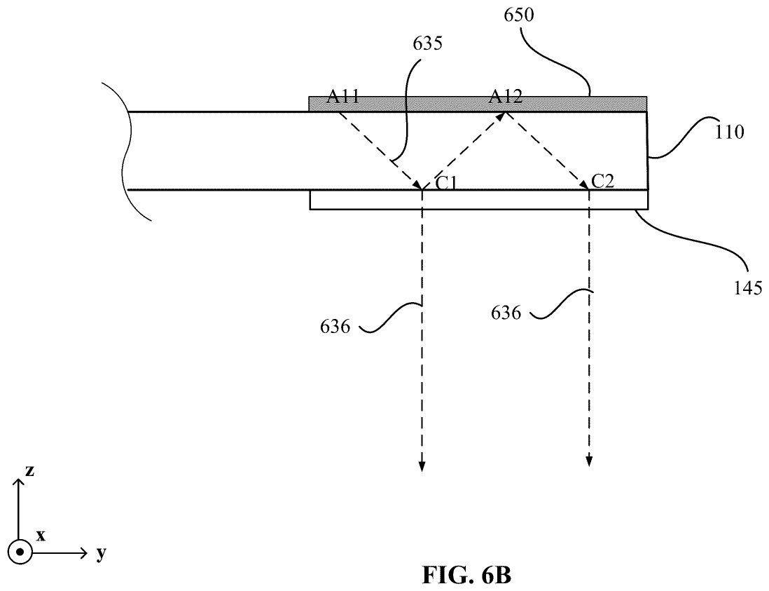

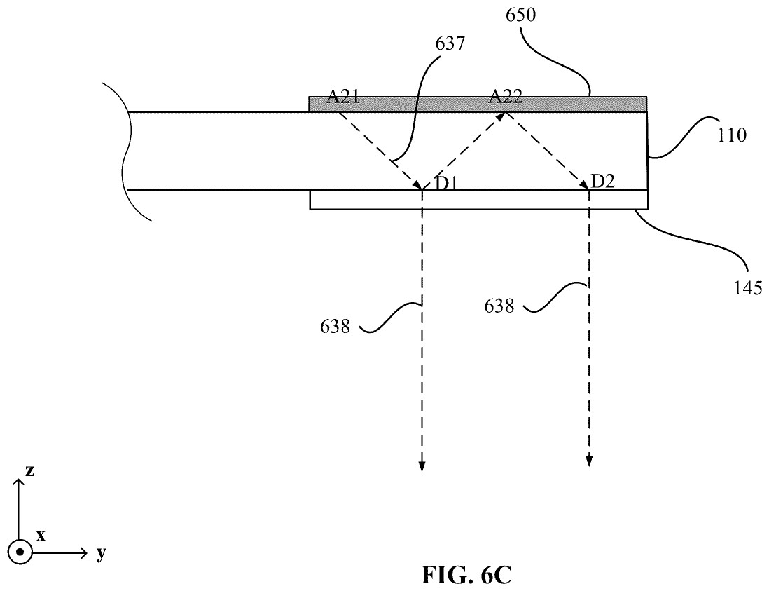

FIG. 6A illustrates a schematic diagram of a light guide display system or assembly 600, FIG. 6B illustrates an a-a′ sectional view of a portion of the light guide display system 600, and FIG. 6C illustrates a b-b′ sectional view of a portion of the light guide display system 600, according to an embodiment of the present disclosure. The light guide display system 600 (or system 600) may include elements that are similar to or the same as those included in the light guide display system 100 shown in FIGS. 1A-1F, the light guide display system 300 shown in FIG. 3, the light guide display system 400 shown in FIGS. 4A and 4B, or the light guide display system 500 shown in FIGS. 5A and 5B. Descriptions of the same or similar elements or features can refer to the above corresponding descriptions, including those rendered in connection with FIGS. 1A-1F, FIG. 3, FIGS. 4A and 4B, or FIGS. 5A and 5B.

As shown in FIG. 6A, the light guide display system 600 may include the controller 115, the light source assembly 105, the light guide 110, the in-coupling element (or input coupler) 135 coupled with the light guide 110 at the input portion of the light guide 110, and the out-coupling element (or output coupler) 145 coupled with the light guide 110 at the output portion of the light guide 110. The light guide display system 600 may also include a freeform volume grating 650 coupled with the light guide 110 at the output portion of the light guide 110. The freeform volume grating 650 may be similar to the freeform volume grating 150 shown in FIGS. 1A-1F, or the freeform volume grating 200 shown in FIGS. 2A-2E. The combination of the light guide 110, the input coupler 135, the output coupler 145, and the freeform volume grating 650 may also be referred to as a light guide image combiner 680.

In some embodiments, as shown in FIG. 6A, the freeform volume grating 650 and the output coupler 145 may be formed or disposed at (e.g., affixed to) different surfaces of the light guide 110, and the freeform volume grating 650 may be disposed opposite to the output coupler 145, e.g., substantially aligned with the output coupler 145 in the thickness direction of the light guide 110. In some embodiments, although not shown, the freeform volume grating 650 and the output coupler 145 may be formed or disposed at (e.g., affixed to) the same surface of the light guide 110. The freeform volume grating 650 may be disposed between the output coupler 145 and the light guide 110, and may be substantially aligned with the output coupler 145. In some embodiments, the freeform volume grating 650 may be directly disposed onto or formed at the first surface 110-1 or the second surface 110-2. In some embodiments, the freeform volume grating 650 may be disposed adjacent the first surface 110-1 or the second surface 110-2 with a gap.

The input coupler 135 may be configured to couple the input image light 130 into the light guide as an in-coupled image light 631 (also referred to as a first TIR propagating image light 631), which may propagate inside the light guide 110 toward the freeform volume grating 650 and the output coupler 145 via TIR. In the embodiment shown in FIGS. 6A and 6B, the freeform volume grating 650 may be configured to expand the TIR propagating image light 631 in a first direction (e.g., the y-axis direction in FIGS. 6A and 6B), and the output coupler 145 may be configured to expand the TIR propagating image light 631 in a second direction (e.g., the x-axis direction in FIGS. 6A and 6B). For discussion purposes, the TIR propagating image light 631 is presumed to propagate within the x-z plane in FIG. 6A.

FIG. 6A illustrates an expansion of the TIR propagating image light 631 in the second direction (e.g., the x-axis direction) via the output coupler 145. FIG. 6B illustrates an a-a′ sectional view of the system 600 shown in FIG. 6A, showing an expansion of the TIR propagating image light 631 in the first direction (e.g., the y-axis direction) via the freeform volume grating 650. FIG. 6C illustrates a b-b′ sectional view of the system 600 shown in FIG. 6A, showing an expansion of the TIR propagating image light 631 in the first direction (e.g., the y-axis direction) via the freeform volume grating 650.

Referring to FIGS. 6A and 6B, when the TIR propagating image light 631 is incident onto different portions of the freeform volume grating 650, the freeform volume grating 650 may diffract the TIR propagating image light 631 as a plurality of image lights propagating inside the light guide 110 via TIR, e.g., within the y-z plane. The portion of the TIR propagating image light 631 that is not diffracted by the freeform volume grating 650 may continue to propagate inside the light guide 110 via TIR, e.g., within the x-z plane. For example, when the TIR propagating image light 631 is incident onto a first portion (e.g., All) of the freeform volume grating 650, the freeform volume grating 650 may diffract the TIR propagating image light 631 as an image light 635 propagating, e.g., within the y-z plane. The image light 635 may propagate inside the light guide 110 via TIR. As shown in FIG. 6B, the output coupler 145 may couple the image light 635 incident onto different portions (e.g., portions indicated by C1 and C2) of the output coupler 145 out of the light guide 110 as a plurality of output image lights 636. The output image lights 636 may be arranged in the first direction (e.g., the y-axis direction).

Referring back to FIG. 6A, the portion of the TIR propagating image light 631 that is not diffracted by the freeform volume grating 650 may continue to propagate inside the light guide 110 via TIR, e.g., within the x-z plane, and may be incident onto a first portion B1 of the output coupler 145. The output coupler 145 may couple the TIR propagating image light 631 incident onto the first portion B1 out of the light guide 110 as an output image light 632-1. The portion of the TIR propagating image light 631 that is not coupled out of the light guide 110 via the output coupler 145 may propagate inside the light guide 110 within the x-z plane, incident onto a second portion A21 of the freeform volume grating 650.

Referring to FIG. 6A and FIG. 6C, when the TIR propagating image light 631 is incident onto the second portion (e.g., A21) of the freeform volume grating 650, the freeform volume grating 650 may diffract the TIR propagating image light 631 as an image light 637 propagating inside the light guide 110 via TIR, within the y-z plane. As shown in FIG. 6C, the output coupler 145 may couple the image light 637 incident onto different portions (e.g., D1 and D2) of the output coupler 145 out of the light guide 110 as a plurality of output image lights 638. The output image lights 638 may be arranged in the first direction (e.g., the y-axis direction). Referring back to FIG. 6A, the portion of the TIR propagating image light 631 that is not diffracted by the freeform volume grating 650 may continue to propagate inside the light guide 110 via TIR, e.g., within the x-z plane, and may be incident onto a second portion B2 of the output coupler 145. The output coupler 145 may couple the TIR propagating image light 631 incident onto the second portion B2 out of the light guide 110 as an output image light 632-2.

The output image lights 632-1 and 632-2 may be arranged in the second direction (e.g., the x-axis direction). In some embodiments, through configuring the freeform volume grating 650, e.g., configuring a predetermined 1D or 2D grating period variation in the one or two dimensions in the film plane of the freeform volume grating 650, the light guide display system 600 may provide a predetermined 1D or 2D angular illuminance distribution and/or spatial illuminance distribution at the output side of the light guide 110, following the same or similar principles in connection with FIGS. 3-4B.

The elements in the light guide display systems and the features of the light guide display systems as described in various embodiments may be combined in any suitable manner. For example, in some embodiments, the light guide 110 shown in FIG. 3 may also be coupled with the freeform volume grating 550 at the input portion and/or the freeform volume grating 650 at the output portion. In some embodiments, the light guide 110 shown in FIGS. 4A and 4B may also be coupled with the freeform volume grating 550 at the input portion and/or the freeform volume grating 650 at the output portion. In some embodiments, the light guide 110 shown in FIGS. 5A and 5B may also be coupled with the freeform volume grating 650 at the output portion, and additionally or alternatively, one of the freeform volume grating 350 shown in FIG. 3 and the freeform volume grating 450 shown in FIGS. 4A and 4B may be disposed inside the light guide 110. In some embodiments, the light guide 110 shown in FIGS. 6A and 6B may also be coupled with the freeform volume grating 550 at the input portion, and additionally or alternatively, one of the freeform volume grating 350 shown in FIG. 3 and the freeform volume grating 450 shown in FIGS. 4A and 4B may be disposed inside the light guide 110.

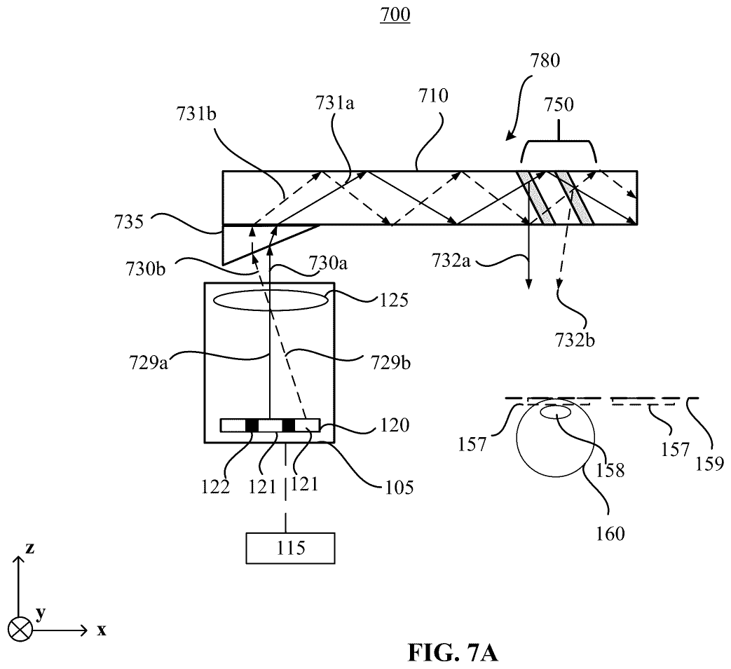

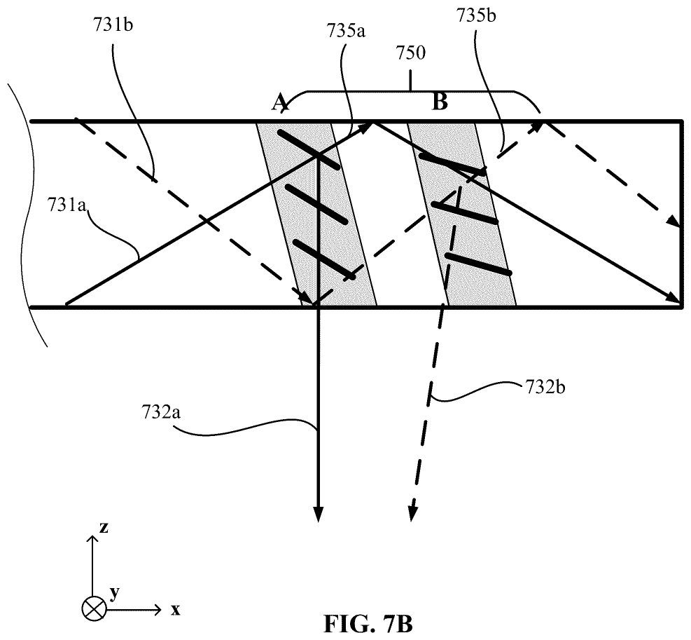

FIG. 7A illustrates a schematic diagram of a light guide display system or assembly 700, according to an embodiment of the present disclosure. The light guide display system 700 may be a geometric light guide (or waveguide) display system. The light guide display system 700 may include elements that are similar to or the same as those included in the light guide display system 100 shown in FIGS. 1A-1F, the light guide display system 300 shown in FIG. 3, the light guide display system 400 shown in FIGS. 4A and 4B, the light guide display system 500 shown in FIGS. 5A and 5B, or the light guide display system 600 shown in FIGS. 6A-6C. Descriptions of the same or similar elements or features can refer to the above corresponding descriptions, including those rendered in connection with FIGS. 1A-1F, FIG. 3, FIGS. 4A and 4B, FIGS. 5A and 5B, or FIGS. 6A-6C.

As shown in FIG. 7A, the light guide display system 700 may include the controller 115, the light source assembly 105, a light guide 710, an input coupler 735 coupled with the light guide 110, and a freeform volume grating 750. The freeform volume grating 750 may be similar to the freeform volume grating 150 shown in FIGS. 1A-1F, or the freeform volume grating 200 shown in FIGS. 2A-2E. The freeform volume grating 750 may function as an output coupler of the light guide 710. The light guide 710 may include, for example, a plastic, a glass, and/or a polymer. The input coupler 735 may be coupled with the light guide 710 at the input portion of the light guide 710. For discussion purposes, FIG. 7A shows the input coupler 735 as a prism. In some embodiments, the input coupler 735 may be another suitable input coupler, such as a grating, or a reflective mirror, etc. In some embodiments, the freeform volume grating 750 may be embedded inside the light guide 710. The combination of the light guide 110, the input coupler 135, the freeform volume grating 750 may also be referred to as a light guide image combiner 780.

For illustrative purposes, FIG. 7A shows that a first image ray 729a and a second image ray 729b are output from two different pixels 121 of the display element 120, e.g. the central pixel 121 and the right pixel 121. The first image ray 729a and the second image ray 729b may have the same wavelength. The collimating lens 125 may convert the respective rays 729a and 729b into a first input ray 730a representing a first FOV direction of the input FOV, and a second input ray 730b representing a second, different FOV direction of the input FOV. The input coupler 735 may couple, via refraction, the first input ray 730a and the second input ray 730b into the light guide 710 as a first in-coupled ray 731a (also referred to as a first TIR propagating ray 731a) and a second in-coupled ray 731b (also referred to as a second TIR propagating ray 731b), respectively. The first TIR propagating ray 731a may propagate inside the light guide 710 through TIR with a first TIR propagation angle, and the second in-coupled ray 731b may propagate inside the light guide 710 through TIR with a second, different TIR propagation angle. For example, FIG. 7A shows that the first TIR propagation angle is greater than the second TIR propagation angle.

The first TIR propagating ray 731a and the second TIR propagating ray 731b may propagate toward the freeform volume grating 750 via TIR. In some embodiments, the freeform volume grating 750 may be configured with at least one of a 1D or 2D tilt angle variation or a 1D or 2D grating period variation along one or two dimensions in the film plane of the freeform volume grating 750, such that the freeform volume grating 750 may couple the first TIR propagating ray 731a and the second TIR propagating ray 731b with different TIR propagation angles out of the light guide 710 toward the eye-box region 159. The freeform volume grating 750 may couple the first TIR propagating ray 731a out of the light guide 710 as a first output ray 732a, and couple the second TIR propagating ray 731b out of the light guide 710 as a second output ray 732b.

FIG. 7B illustrates a portion of the system 700 shown in FIG. 7A, showing the optical paths of the first TIR propagating ray 731a and the second TIR propagating ray 731b propagating through the freeform volume grating 750. As shown in FIG. 7B, the first TIR propagating ray 731a and the second TIR propagating ray 731b may propagate toward the freeform volume grating 750 via TIR, and then propagate through the freeform volume grating 750 from one side (e.g., left side) to the other side (e.g., right side). For illustrative purposes, FIG. 7B shows that the freeform volume grating 750 includes two portions A and B arranged in a longitudinal direction, and has a slant angle variation along the x-axis direction. The portion A may be configured with a first slant angle, and the portion B may be configured with a second, different slant angle. The first and second slant angles of the freeform volume grating 750 may be configured such that the first TIR propagating ray 731a may substantially satisfy the Bragg condition when incident onto the portion A, and may not satisfy the Bragg condition when incident onto the portion B. The second TIR propagating ray 731b may not satisfy the Bragg condition when incident onto the portion A, and may satisfy the Bragg condition when incident onto the portion B. The two portions A and B may be separated from one another with gaps, or with no gaps (i.e., directly stacked together).

As the first TIR propagating ray 731a substantially satisfies the Bragg condition when incident onto the portion A of the freeform volume grating 750, the portion A may diffract the first TIR propagating ray 731a, and couple the first TIR propagating ray 731a out of the light guide 710 as a first output rays 732a, which may represent a first FOV direction of the output FOV. In some embodiments, the portion A may also transmit a portion of the first TIR propagating ray 731a as a transmitted order, e.g., a ray 735a. The transmitted ray 735a may propagate inside the light guide 710 via TIR with the first TIR propagation angle. In some embodiments, the ray 735a may be incident onto the freeform volume grating 750 again, e.g., incident onto the portion B. As the ray 735a does not satisfy the Bragg condition at the portion B of the freeform volume grating 750, the ray 735a may be transmitted through the portion B with zero or negligible diffraction.

As the second TIR propagating ray 731b does not satisfy the Bragg condition when incident onto the portion A of the freeform volume grating 750, the second TIR propagating ray 731b may be transmitted through the portion A with zero or negligible diffraction. As the second TIR propagating ray 731b satisfies the Bragg condition when incident onto the portion B of the freeform volume grating 750, the portion B may diffract the second TIR propagating ray 731b, and couple the second TIR propagating ray 731b out of the light guide 710 as a second output ray 732b, which may represent a second FOV direction of the output FOV. In some embodiments, the portion B may also transmit a portion of the second TIR propagating ray 731b as a transmitted order, e.g., a ray 735b. The transmitted ray 735b may propagate inside the light guide 710 via TIR, with the second TIR propagation angle.

Through configuring the slant angle variation of the freeform volume grating 750, the freeform volume grating 750 may provide respective diffraction efficiencies for the diffracted ray 732a and the diffracted ray 732b. Thus, the output ray 732a and the output ray 732b may be configured with respective desirable light intensities. As the output ray 732a and the output ray 732b represent different FOV directions of the output FOV (e.g., the first FOV direction and the second FOV direction, respectively), a desirable angular illuminance distribution may be achieved at the output side of the light guide 710. For example, in some embodiments, the respective diffraction efficiencies of the freeform volume grating 750 for the diffracted ray 732a and the diffracted ray 732b may be configured to be substantially the same. Thus, the output ray 732a and the output ray 732b may have the same light intensity. As a result, the uniformity of the angular illuminance distribution at the output side of the light guide 710 may be improved.

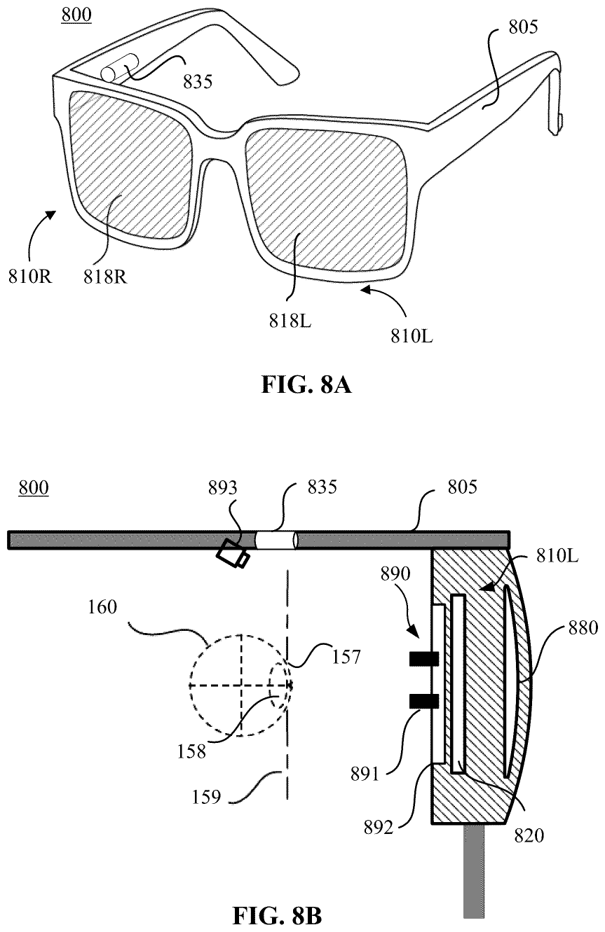

FIG. 8A illustrates a schematic diagram of an artificial reality device 800 according to an embodiment of the present disclosure. In some embodiments, the artificial reality device 800 may present VR, AR, and/or MR content for a user, such as images, video, audio, or a combination thereof. In some embodiments, the artificial reality device 800 may be smart glasses. In one embodiment, the artificial reality device 800 may be a near-eye display (“NED”). In some embodiments, the artificial reality device 800 may be in the form of eyeglasses, goggles, a helmet, a visor, or some other type of eyewear. In some embodiments, the artificial reality device 800 may be configured to be worn on a head of a user (e.g., by having the form of spectacles or eyeglasses, as shown in FIG. 8A), or to be included as part of a helmet that is worn by the user. In some embodiments, the artificial reality device 800 may be configured for placement in proximity to an eye or eyes of the user at a fixed location in front of the eye(s), without being mounted to the head of the user. In some embodiments, the artificial reality device 800 may be in a form of eyeglasses which provide vision correction to a user's eyesight. In some embodiments, the artificial reality device 800 may be in a form of sunglasses which protect the eyes of the user from the bright sunlight. The artificial reality device 800 may be in a form of safety glasses which protect the eyes of the user. In some embodiments, the artificial reality device 800 may be in a form of a night vision device or infrared goggles to enhance a user's vision at night.

For discussion purposes, FIG. 8A shows that the artificial reality device 800 includes a frame 805 configured to mount to a user's head, and left-eye and right-eye display systems 810L and 810R mounted to the frame 805. FIG. 8B is a cross-sectional view of half of the artificial reality device 800 shown in FIG. 8A according to an embodiment of the present disclosure. For illustrative purposes, FIG. 8B shows the cross-sectional view associated with a left-eye display system 810L. The frame 805 is merely an example structure to which various components of the artificial reality device 800 may be mounted. Other suitable type of fixtures may be used in place of or in combination with the frame 805.

In some embodiments, the left-eye and right-eye display systems 810L and 810R may include suitable image display components 820 configured to project computer-generated virtual images into left and right display windows 815L and 815R. In some embodiments, the left-eye and right-eye display systems 810L and 810R may include one or more light guide display systems disclosed herein, such as the light guide display system 100 shown in FIGS. 1A-1F, the light guide display system 300 shown in FIG. 3, the light guide display system 400 shown in FIGS. 4A and 4B, the light guide display system 500 shown in FIGS. 5A and 5B, the light guide display system 600 shown in FIGS. 6A and 6B, or the light guide display system 700 shown in FIGS. 7A-7C. For illustrative purposes, FIGS. 8A and 8B show that the left-eye display systems 810L may include a light source assembly (e.g., a projector) 835 coupled to the frame 805 and configured to generate an image light representing a virtual image. The image light may be output from the light guide display system to propagate through the exit pupil 157 within the eye-box region 159.

As shown in FIG. 8B, the left-eye display systems 810L may also include an object tracking system 890 (e.g., eye tracking system and/or face tracking system). The object tracking system 890 may include an IR light source 891 configured to illuminate the eye 160 and/or the face, a deflecting element 892 (such as a grating), and an optical sensor 893 (such as a camera). The deflecting element 892 may deflect (e.g., diffract) the IR light reflected by the eye 160 toward the optical sensor 893. The optical sensor 893 may generate a tracking signal relating to the eye 160. The tracking signal may be an image of the eye 160. A controller (not shown), such as the controller 115, may control various optical elements based on eye-tracking information obtained from analysis of the image of the eye 160.

In some embodiments, the NED 800 may include an adaptive or active dimming element 880 configured to dynamically adjust the transmittance of lights reflected by real-world objects, thereby switching the NED 800 between a VR device and an AR device or between a VR device and an MR device. The active dimming element 880 may be disposed at a side of the light guide display system facing a real world environment. In some embodiments, along with switching between the AR/MR device and the VR device, the adaptive dimming element 880 may be used in the AR and/MR device to mitigate differences in brightness of lights reflected by real-world objects and virtual image lights.

In some embodiments, the present disclosure provides a device. The device includes a light guide coupled with an in-coupling element at an input portion of the light guide and an out-coupling element at an output portion of the light guide. The device also includes a volume grating disposed at a portion of the light guide and configured to diffract a light via Bragg diffraction. The volume grating is configured with at least one of a predetermined spectral Bragg selectivity variation or a predetermined angular Bragg selectivity variation along one or more dimensions in a film plane of the volume grating.

In some embodiments, the volume grating is disposed inside the light guide between the in-coupling element and the out-coupling element. In some embodiments, the volume grating is configured with a predetermined grating period variation along the one or more dimensions in the film plane of the volume grating, and Bragg planes of the volume grating are configured to be substantially in parallel to the film plane of the volume grating.

In some embodiments, the in-coupling element is configured to couple a first light into the light guide as a second light having a predetermined total internal reflection (“TIR”) propagation angle inside the light guide. At least a portion of the volume grating is configured to partially backwardly diffract the second light as a third light having the predetermined TIR propagation angle inside the light guide, and partially transmit the in-coupled light as a fourth light having the predetermined TIR propagation angle inside the light guide. The out-coupling element is configured to couple the third light and the fourth light out of the light guide.

In some embodiments, the in-coupling element is configured to couple a first input light having a first incidence angle into the light guide as first in-coupled light having a first TIR propagation angle and a second input light having a second, different incidence angle into the light guide as a second in-coupled light having a second, different TIR propagation angle inside the light guide. A first portion of the volume grating is configured to backwardly diffract the first in-coupled light and transmit the second in-coupled light. A second portion of the volume grating is configured to backwardly diffract the second in-coupled light and transmit the first in-coupled light. In some embodiments, the first input light and the second input light have a same incidence wavelength.

In some embodiments, the first portion of the volume grating is configured to partially backwardly diffract the first in-coupled light as a first diffracted light having the first TIR propagation angle inside the light guide, and partially transmit the first in-coupled light as a first transmitted light having the first TIR propagation angle inside the light guide. The second portion of the volume grating is configured to partially backwardly diffract the second in-coupled light as a second diffracted light having the second TIR propagation angle inside the light guide, and partially transmit the second in-coupled light as a second transmitted light having the second TIR propagation angle inside the light guide.

In some embodiments, the out-coupling element is configured to: couple the first diffracted light and the transmitted light out of the light guide as a plurality of first output lights each having a first output angle, and couple the second diffracted light and the transmitted light out of the light guide as a plurality of second output lights each having a second, different output angle.

In some embodiments, the first output lights and the second output lights provide a uniform spatial illuminance distribution, or a predetermined non-uniform spatial illuminance distribution at the output portion of the light guide. In some embodiments, the first output lights and the second output lights provide a uniform angular illuminance distribution, or a predetermined non-uniform angular illuminance distribution at the output portion of the light guide.

In some embodiments, the volume grating is disposed at the input portion of the light guide. The in-coupling element is configured to couple a first portion of an input light into the light guide as a first in-coupled light having a predetermined TIR propagation angle, and transmit a second portion of the input light toward the volume grating. The volume grating is configured to couple the second portion of the input light back into the light guide as a second in-coupled light having the predetermined TIR propagation angle.

In some embodiments, the volume grating and the in-coupling element are disposed at opposites sides or the same side of the light guide.

In some embodiments, the input light is a first input light having a first incidence angle, and the predetermined TIR propagation angle is a first predetermined TIR propagation angle. The in-coupling element is also configured to couple a first portion of a second input light having a second, different incidence angle into the light guide as a third in-coupled light having a second, different predetermined TIR propagation angle, and transmit a second portion of the second input light toward the volume grating. The volume grating is configured to couple the second portion of the second input light back into the light guide as a fourth in-coupled light having the second predetermined TIR propagation angle.

In some embodiments, the out-coupling element is configured to: couple the first and second in-coupled lights out of the light guide as a plurality of first output lights each having a first output angle, and couple the third and fourth in-coupled lights out of the light guide as a plurality of second output lights each having a second, different output angle.

In some embodiments, the first output lights and the second output lights provide a uniform spatial illuminance distribution, or a predetermined non-uniform spatial illuminance distribution at the output portion of the light guide. In some embodiments, the first output lights and the second output lights provide a uniform angular illuminance distribution, or a predetermined non-uniform angular illuminance distribution at the output portion of the light guide.

In some embodiments, the volume grating is disposed at the output portion of the light guide. The in-coupling element is configured to couple an input light into the light guide as an in-coupled light. The volume grating is configured to diffract the in-coupled light toward the out-coupling element.

In some embodiments, the input light is a first input light having a first incidence angle, the in-coupled light is a first input light having a first predetermined TIR propagation angle inside the light guide. The in-coupling element is also configured to couple a second input light having a second, different incidence angle into the light guide as a second in-coupled light having a second, different predetermined TIR propagation angle. The volume grating is configured to diffract the second in-coupled light toward the out-coupling element.

In some embodiments, the out-coupling element is configured to couple the first and second in-coupled lights out of the light guide as a plurality of first output lights each having a first output angle, and a plurality of second output lights each having a second output angle. In some embodiments, the first output lights and the second output lights provide a uniform spatial illuminance distribution, or a predetermined non-uniform spatial illuminance distribution at the output portion of the light guide. In some embodiments, the first output lights and the second output lights provide a uniform angular illuminance distribution, or a predetermined non-uniform angular illuminance distribution at the output portion of the light guide.

In some embodiments, the present disclosure provides a device including a light guide coupled with an in-coupling element at an input portion of the light guide. The device also includes a volume grating embedded in the light guide, and configured with at least one of a predetermined spectral Bragg selectivity variation or a predetermined angular Bragg selectivity variation along one or more dimensions in a film plane of the volume grating. The in-coupling element is configured to couple an input light into the light guide as an in-coupled light propagating toward the volume grating. The volume grating is configured to diffract the in-coupled light out of the light guide.

In some embodiments, the input light is a first input light having a first incidence angle, the in-coupled light is a first input light having a first predetermined TIR propagation angle inside the light guide. The in-coupling element is also configured to couple a second input light having a second, different incidence angle into the light guide as a second in-coupled light having a second, different predetermined TIR propagation angle toward the volume grating. A first portion of the volume grating is configured to diffract the first in-coupled light out of the light guide as a first output light having a first output angle, and transmit the second in-coupled light. A second portion of the volume grating is configured to diffract the second in-coupled light out of the light guide as a second output light having a second output angle, and transmit the first in-coupled light.

In some embodiments, the first output light and the second output light provide a uniform spatial illuminance distribution, or a predetermined non-uniform spatial illuminance distribution at the output portion of the light guide. In some embodiments, the first output light and the second output light provide a uniform angular illuminance distribution, or a predetermined non-uniform angular illuminance distribution at the output portion of the light guide.

The foregoing description of the embodiments of the present disclosure have been presented for the purpose of illustration. It is not intended to be exhaustive or to limit the disclosure to the precise forms disclosed. Persons skilled in the relevant art can appreciate that modifications and variations are possible in beam of the above disclosure.

Any of the steps, operations, or processes described herein may be performed or implemented with one or more hardware and/or software modules, alone or in combination with other devices. In one embodiment, a software module is implemented with a computer program product including a computer-readable medium containing computer program code, which can be executed by a computer processor for performing any or all of the steps, operations, or processes described. In some embodiments, a hardware module may include hardware components such as a device, a system, an optical element, a controller, an electrical circuit, a logic gate, etc.

Embodiments of the present disclosure may also relate to an apparatus for performing the operations herein. This apparatus may be specially constructed for the specific purposes, and/or it may include a general-purpose computing device selectively activated or reconfigured by a computer program stored in the computer. Such a computer program may be stored in a non-transitory, tangible computer readable storage medium, or any type of media suitable for storing electronic instructions, which may be coupled to a computer system bus. The non-transitory computer-readable storage medium can be any medium that can store program codes, for example, a magnetic disk, an optical disk, a read-only memory (“ROM”), or a random access memory (“RAM”), an Electrically Programmable read only memory (“EPROM”), an Electrically Erasable Programmable read only memory (“EEPROM”), a register, a hard disk, a solid-state disk drive, a smart media card (“SMC”), a secure digital card (“SD”), a flash card, etc. Furthermore, any computing systems described in the specification may include a single processor or may be architectures employing multiple processors for increased computing capability. The processor may be a central processing unit (“CPU”), a graphics processing unit (“GPU”), or any processing device configured to process data and/or performing computation based on data. The processor may include both software and hardware components. For example, the processor may include a hardware component, such as an application-specific integrated circuit (“ASIC”), a programmable logic device (“PLD”), or a combination thereof. The PLD may be a complex programmable logic device (“CPLD”), a field-programmable gate array (“FPGA”), etc.

Embodiments of the present disclosure may also relate to a product that is produced by a computing process described herein. Such a product may include information resulting from a computing process, where the information is stored on a non-transitory, tangible computer readable storage medium and may include any embodiment of a computer program product or other data combination described herein.

Further, when an embodiment illustrated in a drawing shows a single element, it is understood that the embodiment or an embodiment not shown in the figures but within the scope of the present disclosure may include a plurality of such elements. Likewise, when an embodiment illustrated in a drawing shows a plurality of such elements, it is understood that the embodiment or an embodiment not shown in the figures but within the scope of the present disclosure may include only one such element. The number of elements illustrated in the drawing is for illustration purposes only, and should not be construed as limiting the scope of the embodiment. Moreover, unless otherwise noted, the embodiments shown in the drawings are not mutually exclusive, and they may be combined in any suitable manner. For example, elements shown in one figure/embodiment but not shown in another figure/embodiment may nevertheless be included in the other figure/embodiment. In any optical device disclosed herein including one or more optical layers, films, plates, or elements, the numbers of the layers, films, plates, or elements shown in the figures are for illustrative purposes only. In other embodiments not shown in the figures, which are still within the scope of the present disclosure, the same or different layers, films, plates, or elements shown in the same or different figures/embodiments may be combined or repeated in various manners to form a stack.

Various embodiments have been described to illustrate the exemplary implementations. Based on the disclosed embodiments, a person having ordinary skills in the art may make various other changes, modifications, rearrangements, and substitutions without departing from the scope of the present disclosure. Thus, while the present disclosure has been described in detail with reference to the above embodiments, the present disclosure is not limited to the above described embodiments. The present disclosure may be embodied in other equivalent forms without departing from the scope of the present disclosure. The scope of the present disclosure is defined in the appended claims.

What is claimed is:

1. A device, comprising:
a light guide coupled with an in-coupling element at an input portion of the light guide and an out-coupling element at an output portion of the light guide; and
a volume grating disposed at a portion of the light guide and configured to diffract a light via Bragg diffraction,
wherein the volume grating is configured with at least one of a predetermined spectral Bragg selectivity variation or a predetermined angular Bragg selectivity variation along one or more dimensions in a film plane of the volume grating.

2. The device of claim 1, wherein the volume grating is embedded inside the light guide between the in-coupling element and the out-coupling element.

3. The device of claim 2, wherein the volume grating is configured with a predetermined grating period variation along the one or more dimensions in the film plane of the volume grating, and Bragg planes of the volume grating are configured to be substantially in parallel to the film plane of the volume grating.

4. The device of claim 2, wherein:
the in-coupling element is configured to couple a first light into the light guide as a second light having a predetermined total internal reflection (“TIR”) propagation angle inside the light guide,
at least a portion of the volume grating is configured to partially backwardly diffract the second light as a third light having the predetermined TIR propagation angle inside the light guide, and partially transmit the in-coupled light as a fourth light having the predetermined TIR propagation angle inside the light guide, and
the out-coupling element is configured to couple the third light and the fourth light out of the light guide.

5. The device of claim 2, wherein:
the in-coupling element is configured to couple a first input light having a first incidence angle into the light guide as first in-coupled light having a first TIR propagation angle and a second input light having a second, different incidence angle into the light guide as a second in-coupled light having a second, different TIR propagation angle inside the light guide,
a first portion of the volume grating is configured to backwardly diffract the first in-coupled light and transmit the second in-coupled light, and
a second portion of the volume grating is configured to backwardly diffract the second in-coupled light and transmit the first in-coupled light.

6. The device of claim 5, wherein the first input light and the second input light have a same incidence wavelength.

7. The device of claim 5, wherein:
the first portion of the volume grating is configured to partially backwardly diffract the first in-coupled light as a first diffracted light having the first TIR propagation angle inside the light guide, and partially transmit the first in-coupled light as a first transmitted light having the first TIR propagation angle inside the light guide, and
the second portion of the volume grating is configured to partially backwardly diffract the second in-coupled light as a second diffracted light having the second TIR propagation angle inside the light guide, and partially transmit the second in-coupled light as a second transmitted light having the second TIR propagation angle inside the light guide.

8. The device of claim 7, wherein the out-coupling element is configured to:
couple the first diffracted light and the transmitted light out of the light guide as a plurality of first output lights each having a first output angle, and
couple the second diffracted light and the transmitted light out of the light guide as a plurality of second output lights each having a second, different output angle.

9. The device of claim 8, wherein the first output lights and the second output lights provide at least one of a uniform spatial illuminance distribution or a uniform angular illuminance distribution at the output portion of the light guide.

10. The device of claim 1, wherein:
the volume grating is disposed at the input portion of the light guide,
the in-coupling element is configured to couple a first portion of an input light into the light guide as a first in-coupled light having a predetermined TIR propagation angle, and transmit a second portion of the input light toward the volume grating, and
the volume grating is configured to couple the second portion of the input light back into the light guide as a second in-coupled light having the predetermined TIR propagation angle.

11. The device of claim 10, wherein the volume grating and the in-coupling element are disposed at opposites sides or the same side of the light guide.

12. The device of claim 10, wherein:
the input light is a first input light having a first incidence angle, and the predetermined TIR propagation angle is a first predetermined TIR propagation angle,
the in-coupling element is also configured to couple a first portion of a second input light having a second, different incidence angle into the light guide as a third in-coupled light having a second, different predetermined TIR propagation angle, and transmit a second portion of the second input light toward the volume grating, and
the volume grating is configured to couple the second portion of the second input light back into the light guide as a fourth in-coupled light having the second predetermined TIR propagation angle.

13. The device of claim 12, wherein the out-coupling element is configured to:
couple the first and second in-coupled lights out of the light guide as a plurality of first output lights each having a first output angle, and
couple the third and fourth in-coupled lights out of the light guide as a plurality of second output lights each having a second, different output angle.

14. The device of claim 1, wherein:
the volume grating is disposed at the output portion of the light guide,
the in-coupling element is configured to couple an input light into the light guide as an in-coupled light, and
the volume grating is configured to diffract the in-coupled light toward the out-coupling element.

15. The device of claim 14, wherein:
the input light is a first input light having a first incidence angle, the in-coupled light is a first input light having a first predetermined TIR propagation angle inside the light guide,
the in-coupling element is also configured to couple a second input light having a second, different incidence angle into the light guide as a second in-coupled light having a second, different predetermined TIR propagation angle, and
the volume grating is configured to diffract the second in-coupled light toward the out-coupling element.

16. The device of claim 14, wherein the out-coupling element is configured to couple the first and second in-coupled lights out of the light guide as a plurality of first output lights each having a first output angle, and a plurality of second output lights each having a second output angle.

17. A device, comprising:
a light guide coupled with an in-coupling element at an input portion of the light guide; and
a volume grating embedded in the light guide, and configured with at least one of a predetermined spectral Bragg selectivity variation or a predetermined angular Bragg selectivity variation along one or more dimensions in a film plane of the volume grating,
wherein the in-coupling element is configured to couple an input light into the light guide as an in-coupled light propagating toward the volume grating, and
wherein the volume grating is configured to diffract the in-coupled light out of the light guide.

18. The device of claim 17, wherein:
the input light is a first input light having a first incidence angle, the in-coupled light is a first input light having a first predetermined TIR propagation angle inside the light guide,
the in-coupling element is also configured to couple a second input light having a second, different incidence angle into the light guide as a second in-coupled light having a second, different predetermined TIR propagation angle toward the volume grating,
a first portion of the volume grating is configured to diffract the first in-coupled light out of the light guide as a first output light having a first output angle, and transmit the second in-coupled light, and
a second portion of the volume grating is configured to diffract the second in-coupled light out of the light guide as a second output light having a second output angle, and transmit the first in-coupled light.

19. The device of claim 17, wherein the first output light and the second output light provide a uniform spatial illuminance distribution, or a predetermined non-uniform spatial illuminance distribution at the output portion of the light guide.

20. The device of claim 17, wherein the first output light and the second output light provide a uniform angular illuminance distribution, or a predetermined non-uniform angular illuminance distribution at the output portion of the light guide.
